(19) United States
(12) Patent Application Publication
(10) Pub. No.: US 2026/0086759 A1
(43) Pub. Date: Mar. 26, 2026

(54) DETERMINING LOCAL SHARED ORIGINS IN THREE-DIMENSIONAL ENVIRONMENTS WITHIN MULTI-USER COMMUNICATION SESSIONS

(71) Applicant: Apple Inc., Cupertino, CA (US)

(72) Inventors: Jacob A. PICCOLO, San Mateo, CA (US); Joseph P. CERRA, San Francisco, CA (US); Patrick PIEMONTE, San Francisco, CA (US); Connor A. SMITH, San Jose, CA (US); Tommy ROCHETTE, Santa Cruz, CA (US); Peter F. HANDEL, San Jose, CA (US)

(21) Appl. No.: 19/310,681

(22) Filed: Aug. 26, 2025

Related U.S. Application Data
(60) Provisional application No. 63/698,521, filed on Sep. 24, 2024.

(51) Int. Cl. G06F 3/14

(52) U.S. Cl. CPC G06F 3/1454

(57) ABSTRACT

Some examples of the disclosure are directed to methods of determining local shared origins in a three-dimensional environment between collocated electronic devices in a communication session. In some examples, a first electronic device detects an indication of a request to engage in a shared activity with a second electronic device and a third electronic device, wherein the first electronic device and the second electronic device share a first origin according to which content is presented in a three-dimensional environment. In some examples, the first electronic device enters a communication session with the second electronic device and the third electronic device. In some examples, the first electronic device obtains first data corresponding to a second origin shared between the second electronic device and the third electronic device. In some examples, the first electronic device determines a shared origin using the first data and second data corresponding to the first origin.

This application claims the benefit of U.S. Provisional Application No. 63/698,521, filed Sep. 24, 2024, the content of which is herein incorporated by reference in its entirety for all purposes.

### FIELD OF THE DISCLOSURE

### Field of the Disclosure

This relates generally to systems and methods of determining local shared origins of three-dimensional environments for electronic devices collocated in a physical environment during multi-user communication sessions.

### Background of the Disclosure

Some computer graphical environments provide two-dimensional and/or three-dimensional environments where at least some objects displayed for a user's viewing are virtual and generated by a computer. In some examples, three-dimensional environments are presented by multiple electronic devices in communication with each other. In some examples, a portal through which to visually communicate with a particular user is displayed in a three-dimensional environment presented at a respective electronic device.

### SUMMARY OF THE DISCLOSURE

Some examples of the disclosure are directed to systems and methods of determining local shared origins in a three-dimensional environment between collocated electronic devices in a multi-user communication session. In some examples, a method is performed at a first electronic device in communication with one or more displays and one or more input devices, wherein the first electronic device is collocated with a second electronic device and a third electronic device in a physical environment. In some examples, the first electronic device detects an indication of a request to engage in a shared activity with the second electronic device and the third electronic device, wherein the first electronic device and the second electronic device share a first origin in the physical environment according to which content is presented in a three-dimensional environment. In some examples, in response to detecting the indication, the first electronic device enters a communication session that includes the first electronic device, the second electronic device, and the third electronic device. In some examples, the first electronic device obtains first data corresponding to a second origin in the physical environment, wherein the second origin is shared between the second electronic device and the third electronic device. In some examples, the first electronic device determines a shared origin in the physical environment using the first data and second data corresponding to the first origin in the physical environment. In some examples, the first electronic device presents, via the one or more displays, an object corresponding to the shared activity at a first location in the three-dimensional environment relative to the shared origin.

The full descriptions of these examples are provided in the Drawings and the Detailed Description, and it is understood that this Summary does not limit the scope of the disclosure in any way.

### BRIEF DESCRIPTION OF THE DRAWINGS

For improved understanding of the various examples described herein, reference should be made to the Detailed Description below along with the following drawings. Like reference numerals often refer to corresponding parts throughout the drawings.

FIG. 1 illustrates an electronic device presenting an extended reality environment according to some examples of the disclosure.

FIG. 2 illustrates a block diagram of an example architecture for a system according to some examples of the disclosure.

FIG. 3 illustrates an example of a spatial group in a multi-user communication session that includes a first electronic device and a second electronic device according to some examples of the disclosure.

FIGS. 4A-4I illustrate examples of determining a local shared origin in a physical environment according to which shared content is displayed in a three-dimensional environment within a multi-user communication session according to some examples of the disclosure.

FIGS. 5A-5C illustrate examples of determining a local shared origin in a physical environment according to which shared content is displayed in a three-dimensional environment within a multi-user communication session according to some examples of the disclosure.

FIG. 6 illustrates a flow diagram illustrating an example process for determining a local shared origin in a physical environment according to which shared content is displayed in a three-dimensional environment within a multi-user communication session according to some examples of the disclosure.

### DETAILED DESCRIPTION

Some examples of the disclosure are directed to systems and methods of determining local shared origins in a three-dimensional environment between collocated electronic devices in a multi-user communication session. In some examples, a method is performed at a first electronic device in communication with one or more displays and one or more input devices, wherein the first electronic device is collocated with a second electronic device and a third electronic device in a physical environment. In some examples, the first electronic device detects an indication of a request to engage in a shared activity with the second electronic device and the third electronic device, wherein the first electronic device and the second electronic device share a first origin in the physical environment according to which content is presented in a three-dimensional environment. In some examples, in response to detecting the indication, the first electronic device enters a communication session that includes the first electronic device, the second electronic device, and the third electronic device. In some examples, the first electronic device obtains first data corresponding to a second origin in the physical environment, wherein the second origin is shared between the second electronic device and the third electronic device. In some examples, the first electronic device determines a shared origin in the physical environment using the first data and second data corresponding to the first origin in the physical environment. In some examples, the first electronic device presents, via the one or more displays, an object corresponding to the shared activity at a first location in the three-dimensional environment relative to the shared origin.

As used herein, a spatial group corresponds to a group or number of participants (e.g., users) in a multi-user communication session. In some examples, a spatial group in the multi-user communication session has a spatial arrangement that dictates locations of users and content that are located in the spatial group. In some examples, users in the same spatial group within the multi-user communication session experience spatial truth according to the spatial arrangement of the spatial group. In some examples, when the user of the first electronic device is in a first spatial group and the user of the second electronic device is in a second spatial group in the multi-user communication session, the users experience spatial truth that is localized to their respective spatial groups. In some examples, while the user of the first electronic device and the user of the second electronic device are grouped into separate spatial groups within the multi-user communication session, if the first electronic device and the second electronic device return to the same operating state, the user of the first electronic device and the user of the second electronic device are regrouped into the same spatial group within the multi-user communication session.

In some examples, initiating a multi-user communication session may include interaction with one or more user interface elements. In some examples, a user's gaze may be tracked by an electronic device as an input for targeting a selectable option/affordance within a respective user interface element that is displayed in the three-dimensional environment. For example, gaze can be used to identify one or more options/affordances targeted for selection using another selection input. In some examples, a respective option/affordance may be selected using hand-tracking input detected via an input device in communication with the electronic device. In some examples, objects displayed in the three-dimensional environment may be moved and/or reoriented in the three-dimensional environment in accordance with movement input detected via the input device.

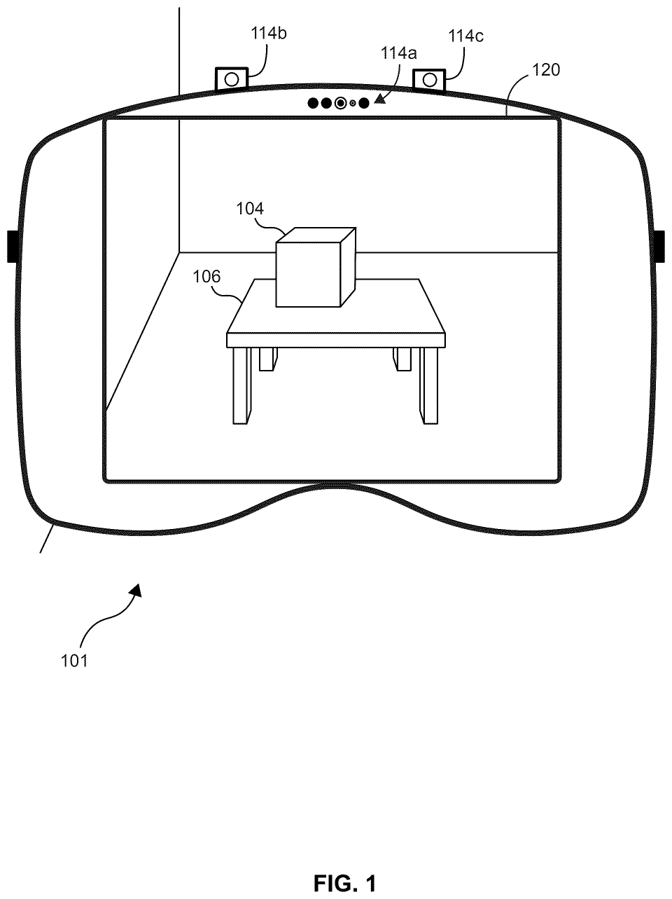

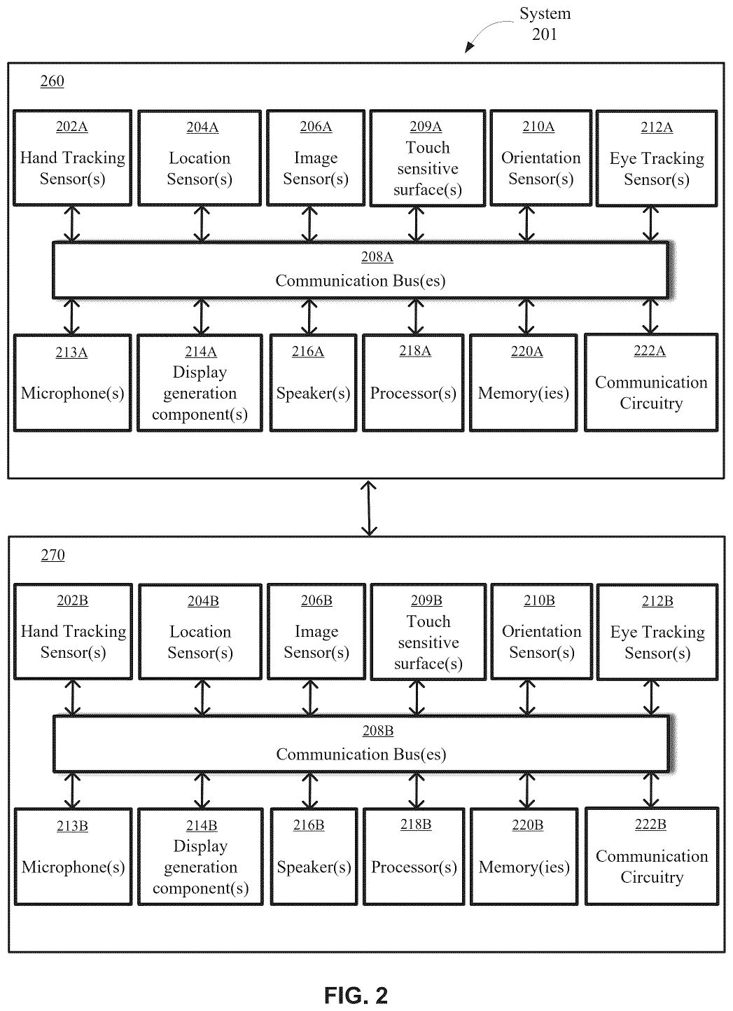

FIG. 1 illustrates an electronic device 101 presenting an extended reality (XR) environment (e.g., a computer-generated environment optionally including representations of physical and/or virtual objects) according to some examples of the disclosure. In some examples, as shown in FIG. 1, electronic device 101 is a head-mounted display or other head-mountable device configured to be worn on a head of a user of the electronic device 101. Examples of electronic device 101 are described below with reference to the architecture block diagram of FIG. 2. As shown in FIG. 1, electronic device 101 and table 106 are located in a physical environment. The physical environment may include physical features such as a physical surface (e.g., floor, walls) or a physical object (e.g., table, lamp, etc.). In some examples, electronic device 101 may be configured to detect and/or capture images of physical environment including table 106 (illustrated in the field of view of electronic device 101).

In some examples, as shown in FIG. 1, electronic device 101 includes one or more internal image sensors 114a oriented towards a face of the user (e.g., eye tracking cameras described below with reference to FIG. 2). In some examples, internal image sensors 114a are used for eye tracking (e.g., detecting a gaze of the user). Internal image sensors 114a are optionally arranged on the left and right portions of display 120 to enable eye tracking of the user's left and right eyes. In some examples, electronic device 101 also includes external image sensors 114b and 114c facing outwards from the user to detect and/or capture the physical environment of the electronic device 101 and/or movements of the user's hands or other body parts.

In some examples, display 120 has a field of view visible to the user (e.g., that may or may not correspond to a field of view of external image sensors 114b and 114c). Because display 120 is optionally part of a head-mounted device, the field of view of display 120 is optionally the same as or similar to the field of view of the user's eyes. In other examples, the field of view of display 120 may be smaller than the field of view of the user's eyes. In some examples, electronic device 101 may be an optical see-through device in which display 120 is a transparent or translucent display through which portions of the physical environment may be directly viewed. In some examples, display 120 may be included within a transparent lens and may overlap all or only a portion of the transparent lens. In other examples, electronic device may be a video-passthrough device in which display 120 is an opaque display configured to display images of the physical environment captured by external image sensors 114b and 114c. While a single display 120 is shown, it should be appreciated that display 120 may include a stereo pair of displays.

In some examples, in response to a trigger, the electronic device 101 may be configured to display a virtual object 104 in the XR environment represented by a cube illustrated in FIG. 1, which is not present in the physical environment, but is displayed in the XR environment positioned on the top of real-world table 106 (or a representation thereof). Optionally, virtual object 104 can be displayed on the surface of the table 106 in the XR environment displayed via the display 120 of the electronic device 101 in response to detecting the planar surface of table 106 in the physical environment 100.

It should be understood that virtual object 104 is a representative virtual object and one or more different virtual objects (e.g., of various dimensionality such as two-dimensional or other three-dimensional virtual objects) can be included and rendered in a three-dimensional XR environment. For example, the virtual object can represent an application or a user interface displayed in the XR environment. In some examples, the virtual object can represent content corresponding to the application and/or displayed via the user interface in the XR environment. In some examples, the virtual object 104 is optionally configured to be interactive and responsive to user input (e.g., air gestures, such as air pinch gestures, air tap gestures, and/or air touch gestures), such that a user may virtually touch, tap, move, rotate, or otherwise interact with, the virtual object 104.

In some examples, displaying an object in a three-dimensional environment may include interaction with one or more user interface objects in the three-dimensional environment. For example, initiation of display of the object in the three-dimensional environment can include interaction with one or more virtual options/affordances displayed in the three-dimensional environment. In some examples, a user's gaze may be tracked by the electronic device as an input for identifying one or more virtual options/affordances targeted for selection when initiating display of an object in the three-dimensional environment. For example, gaze can be used to identify one or more virtual options/affordances targeted for selection using another selection input. In some examples, a virtual option/affordance may be selected using hand-tracking input detected via an input device in communication with the electronic device. In some examples, objects displayed in the three-dimensional environment may be moved and/or reoriented in the three-dimensional environment in accordance with movement input detected via the input device.

In the discussion that follows, an electronic device that is in communication with a display generation component and one or more input devices is described. It should be understood that the electronic device optionally is in communication with one or more other physical user-interface devices, such as a touch-sensitive surface, a physical keyboard, a mouse, a joystick, a hand tracking device, an eye tracking device, a stylus, etc. Further, as described above, it should be understood that the described electronic device, display and touch-sensitive surface are optionally distributed amongst two or more devices. Therefore, as used in this disclosure, information displayed on the electronic device or by the electronic device is optionally used to describe information outputted by the electronic device for display on a separate display device (touch-sensitive or not). Similarly, as used in this disclosure, input received on the electronic device (e.g., touch input received on a touch-sensitive surface of the electronic device, or touch input received on the surface of a stylus) is optionally used to describe input received on a separate input device, from which the electronic device receives input information.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, a television channel browsing application, and/or a digital video player application.

FIG. 2 illustrates a block diagram of an example architecture for a system 201 according to some examples of the disclosure. In some examples, system 201 includes multiple electronic devices. For example, the system 201 includes a first electronic device 260 and a second electronic device 270, wherein the first electronic device 260 and the second electronic device 270 are in communication with each other. In some examples, the first electronic device 260 and/or the second electronic device 270 are a portable device, an auxiliary device in communication with another device, a head-mounted display, etc., respectively. In some examples, the first electronic device 260 and the second electronic device 270 correspond to electronic device 101 described above with reference to FIG. 1.

As illustrated in FIG. 2, the first electronic device 260 and the second electronic device 270 optionally include various sensors, such as one or more hand tracking sensors 202A/202B, one or more location sensors 204A/204B, one or more image sensors 206A/206B (optionally corresponding to internal image sensors 114a and/or external image sensors 114b and 114c in FIG. 1), one or more touch-sensitive surfaces 209A/209B, one or more motion and/or orientation sensors 210A/210B, one or more eye tracking sensors 212A/212B, one or more microphones 213A/213B or other audio sensors, one or more body tracking sensors (e.g., torso and/or head tracking sensors), one or more display generation components 214A/214B, optionally corresponding to display 120 in FIG. 1, one or more speakers 216A/216B, one or more processors 218A/218B, one or more memories 220A/220B, and/or communication circuitry 222A/222B. One or more communication buses 208A/208B are optionally used for communication between the above-mentioned components of the electronic devices 260 and 270.

Communication circuitry 222A/222B optionally includes circuitry for communicating with electronic devices, networks, such as the Internet, intranets, a wired network and/or a wireless network, cellular networks, and wireless local area networks (LANs). Communication circuitry 222A/222B optionally includes circuitry for communicating using near-field communication (NFC) and/or short-range communication, such as Bluetooth®.

Processor(s) 218A/218B include one or more general processors, one or more graphics processors, and/or one or more digital signal processors. In some examples, memory 220A/220B is a non-transitory computer-readable storage medium (e.g., flash memory, random access memory, or other volatile or non-volatile memory or storage) that stores computer-readable instructions configured to be executed by processor(s) 218A/218B to perform the techniques, processes, and/or methods described below. In some examples, memory 220A/220B can include more than one non-transitory computer-readable storage medium. A non-transitory computer-readable storage medium can be any medium (e.g., excluding a signal) that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on compact disc (CD), digital versatile disc (DVD), or Blu-ray technologies, as well as persistent solid-state memory such as flash, solid-state drives, and the like.

In some examples, display generation component(s) 214A/214B include a single display (e.g., a liquid-crystal display (LCD), organic light-emitting diode (OLED), or other types of display). In some examples, display generation component(s) 214A/214B include multiple displays. In some examples, display generation component(s) 214A/214B can include a display with touch capability (e.g., a touch screen), a projector, a holographic projector, a retinal projector, a transparent or translucent display, etc. In some examples, the first and second electronic devices 260 and 270 include touch-sensitive surface(s) 209A/209B, respectively, for receiving user inputs, such as tap inputs and swipe inputs or other gestures. In some examples, display generation component(s) 214A/214B and touch-sensitive surface(s) 209A/209B form touch-sensitive display(s) (e.g., a touch screen integrated with electronic devices 260 and 270 or external to electronic devices 260 and 270 that is in communication with electronic devices 260 and 270).

Electronic devices 260 and 270 optionally include image sensor(s) 206A/206B. Image sensors(s) 206A/206B optionally include one or more visible light image sensors, such as charged coupled device (CCD) sensors, and/or complementary metal-oxide-semiconductor (CMOS) sensors operable to obtain images of physical objects from the real-world environment. Image sensor(s) 206A/206B also optionally include one or more infrared (IR) sensors, such as a passive or an active IR sensor, for detecting infrared light from the real-world environment. For example, an active IR sensor includes an IR emitter for emitting infrared light into the real-world environment. Image sensor(s) 206A/206B also optionally include one or more cameras configured to capture movement of physical objects in the real-world environment. Image sensor(s) 206A/206B also optionally include one or more depth sensors configured to detect the distance of physical objects from electronic devices 260 and 270. In some examples, information from one or more depth sensors can allow the device to identify and differentiate objects in the real-world environment from other objects in the real-world environment. In some examples, one or more depth sensors can allow the device to determine the texture and/or topography of objects in the real-world environment.

In some examples, electronic devices 260 and 270 use CCD sensors, event cameras, and depth sensors in combination to detect the physical environment around electronic devices 260 and 270. In some examples, image sensor(s) 206A/206B include a first image sensor and a second image sensor. The first image sensor and the second image sensor work in tandem and are optionally configured to capture different information of physical objects in the real-world environment. In some examples, the first image sensor is a visible light image sensor and the second image sensor is a depth sensor. In some examples, electronic devices 260 and 270 use image sensor(s) 206A/206B to detect the position and orientation of electronic devices 260 and 270 and/or display generation component(s) 214A/214B in the real-world environment. For example, electronic devices 260 and 270 use image sensor(s) 206A/206B to track the position and orientation of display generation component(s) 214A/214B relative to one or more fixed objects in the real-world environment.

In some examples, electronic devices 260 and 270 include microphone(s) 213A/213B or other audio sensors. Electronic devices 260 and 270 optionally use microphone(s) 213A/213B to detect sound from the user and/or the real-world environment of the user. In some examples, microphone(s) 213A/213B include an array of microphones (a plurality of microphones) that optionally operate in tandem, such as to identify ambient noise or to locate the source of sound in space of the real-world environment.

Electronic devices 260 and 270 include location sensor(s) 204A/204B for detecting a location of electronic devices 260 and 270 and/or display generation component(s) 214A/214B. For example, location sensor(s) 204A/204B can include a global positioning system (GPS) receiver that receives data from one or more satellites and allows electronic devices 260 and 270 to determine the devices' absolute positions in the physical world.

Electronic devices 260 and 270 include orientation sensor(s) 210A/210B for detecting orientation and/or movement of electronic devices 260 and 270 and/or display generation component(s) 214A/214B. For example, electronic devices 260 and 270 use orientation sensor(s) 210A/210B to track changes in the position and/or orientation of electronic devices 260 and 270 and/or display generation component(s) 214A/214B, such as with respect to physical objects in the real-world environment. Orientation sensor(s) 210A/210B optionally include one or more gyroscopes and/or one or more accelerometers.

Electronic devices 260 and 270 include hand tracking sensor(s) 202A/202B and/or eye tracking sensor(s) 212A/212B (and/or other body tracking sensor(s), such as leg, torso and/or head tracking sensor(s)), in some examples. Hand tracking sensor(s) 202A/202B are configured to track the position/location of one or more portions of the user's hands, and/or motions of one or more portions of the user's hands with respect to the extended reality environment, relative to the display generation component(s) 214A/214B, and/or relative to another defined coordinate system. Eye tracking sensor(s) 212A/212B are configured to track the position and movement of a user's gaze (eyes, face, or head, more generally) with respect to the real-world or extended reality environment and/or relative to the display generation component(s) 214A/214B. In some examples, hand tracking sensor(s) 202A/202B and/or eye tracking sensor(s) 212A/212B are implemented together with the display generation component(s) 214A/214B. In some examples, the hand tracking sensor(s) 202A/202B and/or eye tracking sensor(s) 212A/212B are implemented separate from the display generation component(s) 214A/214B.

In some examples, the hand tracking sensor(s) 202A/202B (and/or other body tracking sensor(s), such as leg, torso and/or head tracking sensor(s)) can use image sensor(s) 206A/206B (e.g., one or more IR cameras, 3D cameras, depth cameras, etc.) that capture three-dimensional information from the real-world including one or more body parts (e.g., hands, legs, or torso of a human user). In some examples, the hands can be resolved with sufficient resolution to distinguish fingers and their respective positions. In some examples, one or more image sensors 206A/206B are positioned relative to the user to define a field of view of the image sensor(s) 206A/206B and an interaction space in which finger/hand position, orientation and/or movement captured by the image sensors are used as inputs (e.g., to distinguish from a user's resting hand or other hands of other persons in the real-world environment). Tracking the fingers/hands for input (e.g., gestures, touch, tap, etc.) can be advantageous in that it does not require the user to touch, hold or wear any sort of beacon, sensor, or other marker.

In some examples, eye tracking sensor(s) 212A/212B includes at least one eye tracking camera (e.g., infrared (IR) cameras) and/or illumination sources (e.g., IR light sources, such as LEDs) that emit light towards a user's eyes. The eye tracking cameras may be pointed towards a user's eyes to receive reflected IR light from the light sources directly or indirectly from the eyes. In some examples, both eyes are tracked separately by respective eye tracking cameras and illumination sources, and a focus/gaze can be determined from tracking both eyes. In some examples, one eye (e.g., a dominant eye) is tracked by one or more respective eye tracking cameras/illumination sources.

Electronic devices 260 and 270 are not limited to the components and configuration of FIG. 2, but can include fewer, other, or additional components in multiple configurations. In some examples, system 201 can be implemented in a single device. A person or persons using electronic devices 260/270, is optionally referred to herein as a user or users of the device(s). Attention is now directed towards exemplary concurrent displays of a three-dimensional environment on a first electronic device (e.g., corresponding to electronic device 260) and a second electronic device (e.g., corresponding to electronic device 270). As discussed below, the first electronic device may be in communication with the second electronic device in a multi-user communication session. In some examples, an avatar (e.g., a representation of) a user of the first electronic device may be displayed in the three-dimensional environment at the second electronic device, and an avatar of a user of the second electronic device may be displayed in the three-dimensional environment at the first electronic device. In some examples, the user of the first electronic device and the user of the second electronic device may be associated with a spatial group in the multi-user communication session.

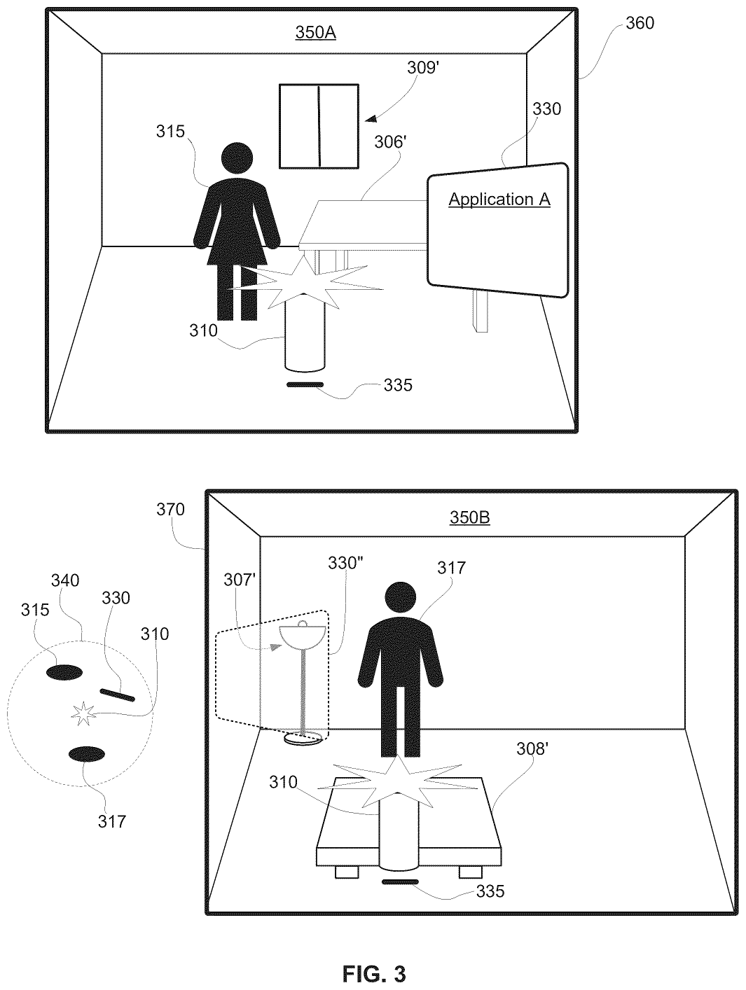

FIG. 3 illustrates an example of a spatial group 340 in a multi-user communication session that includes a first electronic device 360 and a second electronic device 370 according to some examples of the disclosure. In some examples, the first electronic device 360 may present a three-dimensional environment 350A, and the second electronic device 370 may present a three-dimensional environment 350B. The first electronic device 360 and the second electronic device 370 may be similar to electronic device 101 or 260/270, and/or may be a head mountable system/device and/or projection-based system/device (including a hologram-based system/device) configured to generate and present a three-dimensional environment, such as, for example, heads-up displays (HUDs), head mounted displays (HMDs), windows having integrated display capability, displays formed as lenses designed to be placed on a person's eyes (e.g., similar to contact lenses), respectively. In the example of FIG. 3, a first user is optionally wearing the first electronic device 360 and a second user is optionally wearing the second electronic device 370, such that the three-dimensional environment 350A/350B can be defined by X, Y and Z axes as viewed from a perspective of the electronic devices (e.g., a viewpoint associated with the electronic device 360/370, which may be a head-mounted display, for example).

As shown in FIG. 3, the first electronic device 360 may be in a first physical environment that includes a table 306 and a window 309. Thus, the three-dimensional environment 350A presented using the first electronic device 360 optionally includes captured portions of the physical environment surrounding the first electronic device 360, such as a representation of the table 306′ and a representation of the window 309′. Similarly, the second electronic device 370 may be in a second physical environment, different from the first physical environment (e.g., separate from the first physical environment), that includes a floor lamp 307 and a coffee table 308. Thus, the three-dimensional environment 350B presented using the second electronic device 370 optionally includes captured portions of the physical environment surrounding the second electronic device 370, such as a representation of the floor lamp 307′ and a representation of the coffee table 308′. Additionally, the three-dimensional environments 350A and 350B may include representations of the floor, ceiling, and walls of the room in which the first electronic device 360 and the second electronic device 370, respectively, are located.

As mentioned above, in some examples, the first electronic device 360 is optionally in a multi-user communication session with the second electronic device 370. For example, the first electronic device 360 and the second electronic device 370 (e.g., via communication circuitry 222A/222B) are configured to present a shared three-dimensional environment 350A/350B that includes one or more shared virtual objects (e.g., content such as images, video, audio and the like, representations of user interfaces of applications, etc.). As used herein, the term “shared three-dimensional environment” refers to a three-dimensional environment that is independently presented, displayed, and/or visible at two or more electronic devices via which content, applications, data, and the like may be shared and/or presented to users of the two or more electronic devices. In some examples, while the first electronic device 360 is in the multi-user communication session with the second electronic device 370, an avatar corresponding to the user of one electronic device is optionally displayed in the three-dimensional environment that is displayed via the other electronic device. For example, as shown in FIG. 3, at the first electronic device 360, an avatar 315 corresponding to the user of the second electronic device 370 is displayed in the three-dimensional environment 350A. Similarly, at the second electronic device 370, an avatar 317 corresponding to the user of the first electronic device 360 is displayed in the three-dimensional environment 350B.

In some examples, the presentation of avatars 315/317 as part of a shared three-dimensional environment is optionally accompanied by an audio effect corresponding to a voice of the users of the electronic devices 370/360. For example, the avatar 315 displayed in the three-dimensional environment 350A using the first electronic device 360 is optionally accompanied by an audio effect corresponding to the voice of the user of the second electronic device 370. In some such examples, when the user of the second electronic device 370 speaks, the voice of the user may be detected by the second electronic device 370 (e.g., via the microphone(s) 213B) and transmitted to the first electronic device 360 (e.g., via the communication circuitry 222B/222A), such that the detected voice of the user of the second electronic device 370 may be presented as audio (e.g., using speaker(s) 216A) to the user of the first electronic device 360 in three-dimensional environment 350A. In some examples, the audio effect corresponding to the voice of the user of the second electronic device 370 may be spatialized such that it appears to the user of the first electronic device 360 to emanate from the location of avatar 315 in the shared three-dimensional environment 350A (e.g., despite being outputted from the speakers of the first electronic device 360). Similarly, the avatar 317 displayed in the three-dimensional environment 350B using the second electronic device 370 is optionally accompanied by an audio effect corresponding to the voice of the user of the first electronic device 360. In some such examples, when the user of the first electronic device 360 speaks, the voice of the user may be detected by the first electronic device 360 (e.g., via the microphone(s) 213A) and transmitted to the second electronic device 370 (e.g., via the communication circuitry 222A/222B), such that the detected voice of the user of the first electronic device 360 may be presented as audio (e.g., using speaker(s) 216B) to the user of the second electronic device 370 in three-dimensional environment 350B. In some examples, the audio effect corresponding to the voice of the user of the first electronic device 360 may be spatialized such that it appears to the user of the second electronic device 370 to emanate from the location of avatar 317 in the shared three-dimensional environment 350B (e.g., despite being outputted from the speakers of the first electronic device 360).

In some examples, while in the multi-user communication session, the avatars 315/317 are displayed in the three-dimensional environments 350A/350B with respective orientations that correspond to and/or are based on orientations of the electronic devices 360/370 (and/or the users of electronic devices 360/370) in the physical environments surrounding the electronic devices 360/370. For example, as shown in FIG. 3, in the three-dimensional environment 350A, the avatar 315 is optionally facing toward the viewpoint of the user of the first electronic device 360, and in the three-dimensional environment 350B, the avatar 317 is optionally facing toward the viewpoint of the user of the second electronic device 370. As a particular user moves the electronic device (and/or themself) in the physical environment, the viewpoint of the user changes in accordance with the movement, which may thus also change an orientation of the user's avatar in the three-dimensional environment. For example, with reference to FIG. 3, if the user of the first electronic device 360 were to look leftward in the three-dimensional environment 350A such that the first electronic device 360 is rotated (e.g., a corresponding amount) to the left (e.g., counterclockwise), the user of the second electronic device 370 would see the avatar 317 corresponding to the user of the first electronic device 360 rotate to the right (e.g., clockwise) relative to the viewpoint of the user of the second electronic device 370 in accordance with the movement of the first electronic device 360.

Additionally, in some examples, while in the multi-user communication session, a viewpoint of the three-dimensional environments 350A/350B and/or a location of the viewpoint of the three-dimensional environments 350A/350B optionally changes in accordance with movement of the electronic devices 360/370 (e.g., by the users of the electronic devices 360/370). For example, while in the communication session, if the first electronic device 360 is moved closer toward the representation of the table 306′ and/or the avatar 315 (e.g., because the user of the first electronic device 360 moved forward in the physical environment surrounding the first electronic device 360), the viewpoint of the three-dimensional environment 350A would change accordingly, such that the representation of the table 306′, the representation of the window 309′ and the avatar 315 appear larger in the field of view. In some examples, each user may independently interact with the three-dimensional environment 350A/350B, such that changes in viewpoints of the three-dimensional environment 350A and/or interactions with virtual objects in the three-dimensional environment 350A by the first electronic device 360 optionally do not affect what is shown in the three-dimensional environment 350B at the second electronic device 370, and vice versa.

In some examples, the avatars 315/317 are a representation (e.g., a full-body rendering) of the users of the electronic devices 370/360. In some examples, the avatar 315/317 is a representation of a portion (e.g., a rendering of a head, face, head and torso, etc.) of the users of the electronic devices 370/360. In some examples, the avatars 315/317 are a user-personalized, user-selected, and/or user-created representation displayed in the three-dimensional environments 350A/350B that is representative of the users of the electronic devices 370/360. It should be understood that, while the avatars 315/317 illustrated in FIG. 3 correspond to full-body representations of the users of the electronic devices 370/360, respectively, alternative avatars may be provided, such as those described above.

As mentioned above, while the first electronic device 360 and the second electronic device 370 are in the multi-user communication session, the three-dimensional environments 350A/350B may be a shared three-dimensional environment that is presented using the electronic devices 360/370. In some examples, content that is viewed by one user at one electronic device may be shared with another user at another electronic device in the multi-user communication session. In some such examples, the content may be experienced (e.g., viewed and/or interacted with) by both users (e.g., via their respective electronic devices) in the shared three-dimensional environment. For example, as shown in FIG. 3, the three-dimensional environments 350A/350B include a shared virtual object 310 (e.g., which is optionally a three-dimensional virtual sculpture) that is viewable by and interactive to both users. As shown in FIG. 3, the shared virtual object 310 may be displayed with a grabber affordance (e.g., a handlebar) 335 that is selectable to initiate movement of the shared virtual object 310 within the three-dimensional environments 350A/350B.

In some examples, the three-dimensional environments 350A/350B include unshared content that is private to one user in the multi-user communication session. For example, in FIG. 3, the first electronic device 360 is displaying a private application window 330 in the three-dimensional environment 350A, which is optionally an object that is not shared between the first electronic device 360 and the second electronic device 370 in the multi-user communication session. In some examples, the private application window 330 may be associated with a respective application that is operating on the first electronic device 360 (e.g., such as a media player application, a web browsing application, a messaging application, etc.). Because the private application window 330 is not shared with the second electronic device 370, the second electronic device 370 optionally displays a representation of the private application window 330″ in three-dimensional environment 350B. As shown in FIG. 3, in some examples, the representation of the private application window 330″ may be a faded, occluded, discolored, and/or translucent representation of the private application window 330 that prevents the user of the second electronic device 370 from viewing contents of the private application window 330.

As mentioned previously above, in some examples, the user of the first electronic device 360 and the user of the second electronic device 370 are in a spatial group 340 within the multi-user communication session. In some examples, the spatial group 340 may be a baseline (e.g., a first or default) spatial group within the multi-user communication session. For example, when the user of the first electronic device 360 and the user of the second electronic device 370 initially join the multi-user communication session, the user of the first electronic device 360 and the user of the second electronic device 370 are automatically (and initially, as discussed in more detail below) associated with (e.g., grouped into) the spatial group 340 within the multi-user communication session. In some examples, while the users are in the spatial group 340 as shown in FIG. 3, the user of the first electronic device 360 and the user of the second electronic device 370 have a first spatial arrangement (e.g., first spatial template) within the shared three-dimensional environment. For example, the user of the first electronic device 360 and the user of the second electronic device 370, including objects that are displayed in the shared three-dimensional environment, have spatial truth within the spatial group 340. In some examples, spatial truth requires a consistent spatial arrangement between users (or representations thereof) and virtual objects. For example, a distance between the viewpoint of the user of the first electronic device 360 and the avatar 315 corresponding to the user of the second electronic device 370 may be the same as a distance between the viewpoint of the user of the second electronic device 370 and the avatar 317 corresponding to the user of the first electronic device 360. As described herein, if the location of the viewpoint of the user of the first electronic device 360 moves, the avatar 317 corresponding to the user of the first electronic device 360 moves in the three-dimensional environment 350B in accordance with the movement of the location of the viewpoint of the user relative to the viewpoint of the user of the second electronic device 370. Additionally, if the user of the first electronic device 360 performs an interaction on the shared virtual object 310 (e.g., moves the virtual object 310 in the three-dimensional environment 350A), the second electronic device 370 alters display of the shared virtual object 310 in the three-dimensional environment 350B in accordance with the interaction (e.g., moves the virtual object 310 in the three-dimensional environment 350B).

It should be understood that, in some examples, more than two electronic devices may be communicatively linked in a multi-user communication session. For example, in a situation in which three electronic devices are communicatively linked in a multi-user communication session, a first electronic device would display two avatars, rather than just one avatar, corresponding to the users of the other two electronic devices. It should therefore be understood that the various processes and exemplary interactions described herein with reference to the first electronic device 360 and the second electronic device 370 in the multi-user communication session optionally apply to situations in which more than two electronic devices are communicatively linked in a multi-user communication session.

In some examples, it may be advantageous to provide mechanisms for facilitating a multi-user communication session that includes collocated users (e.g., collocated electronic devices associated with the users). For example, it may be desirable to enable users who are collocated in a first physical environment to establish a multi-user communication session, such that virtual content may be shared and presented in a three-dimensional environment that is optionally viewable by and/or interactive to the collocated users in the multi-user communication session. As used herein, relative to a first electronic device, a collocated user corresponds to a local user. In some examples, as discussed below, the presentation of virtual objects (e.g., avatars and shared virtual content) in the three-dimensional environment within a multi-user communication session that includes collocated users (e.g., relative to a first electronic device) is based on establishing a shared coordinate space/system based on at least the poses (e.g., positions and/or orientations) of the collocated users in a physical environment of the first electronic device. Particularly, unlike a multi-user communication session comprised of solely remote users (e.g., non-collocated users) in which a shared origin of the three-dimensional environment (e.g., according to which content is presented) is able to be determined/placed at any location relative to a first user's physical environment, a multi-user communication session that comprises solely collocated users requires agreement and/or collaboration between the electronic devices on the placement of the shared origin of the three-dimensional environment. For example, as discussed herein, because collocated users are represented in the multi-user communication session by their physical bodies that are not freely movable by the first electronic device (e.g., as opposed to avatars which are freely movable), the shared origin of the three-dimensional environment need be agreed upon by the electronic devices in the multi-user communication session. In some examples, as discussed below, the shared origin of the three-dimensional environment for the collocated users in the multi-user communication session is determined based on individual origins that are local to and/or determined individually by the electronic devices associated with the collocated users.

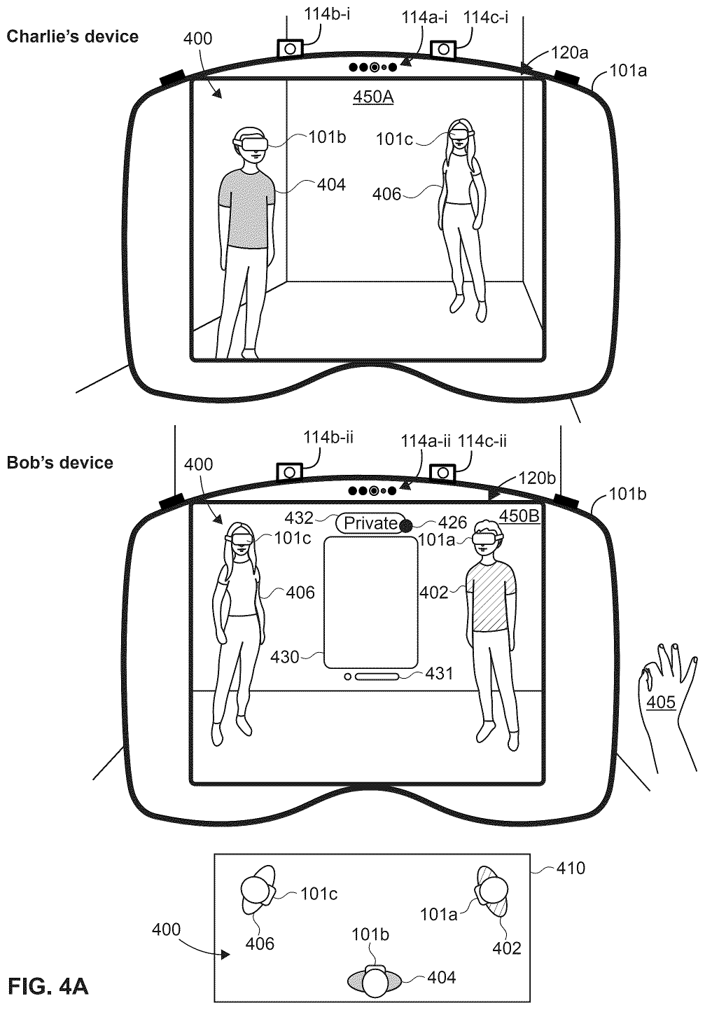

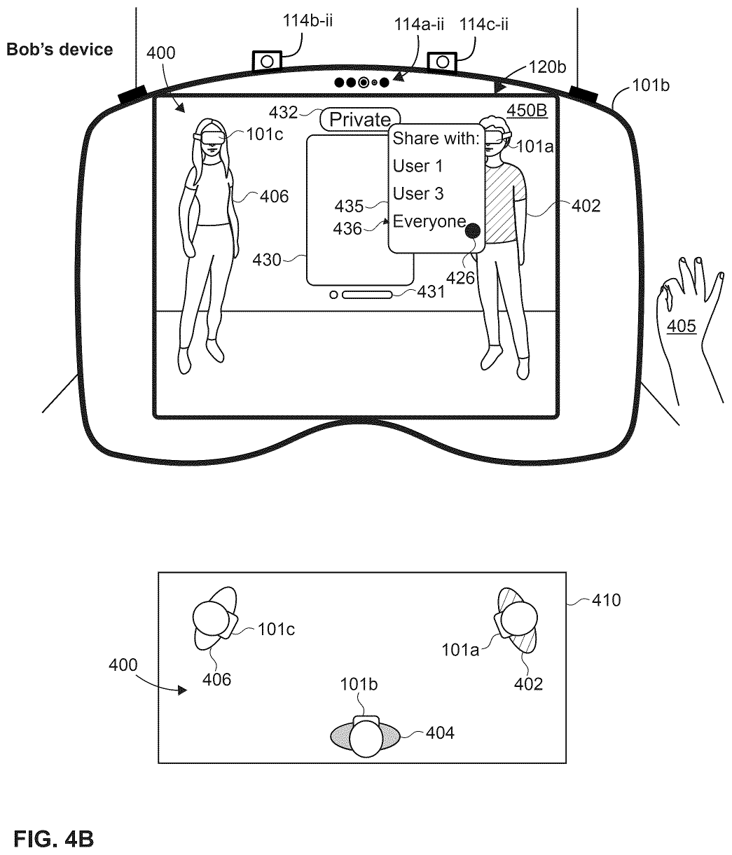

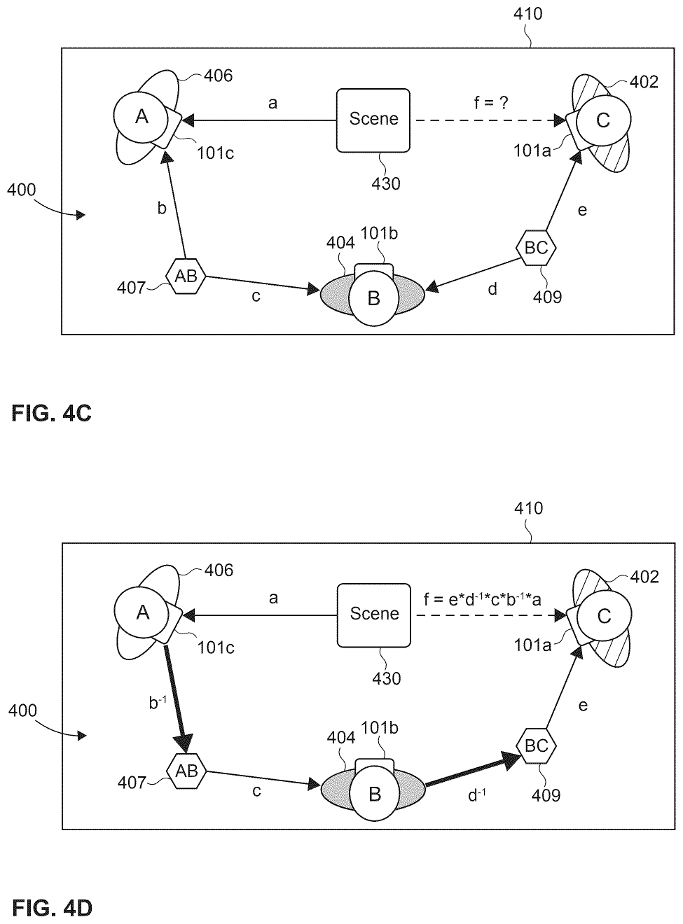

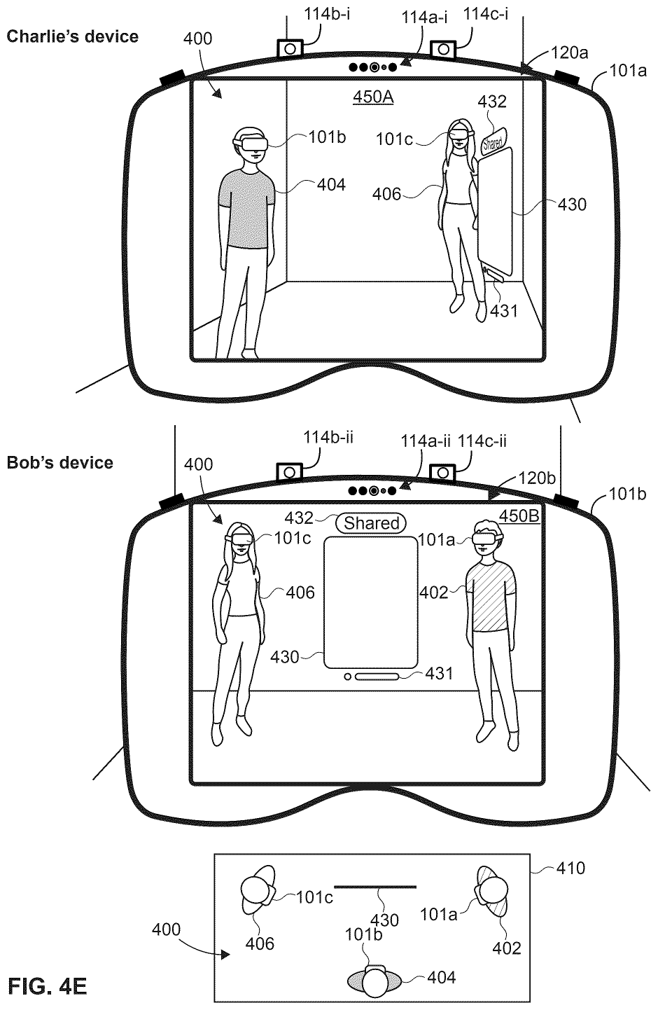

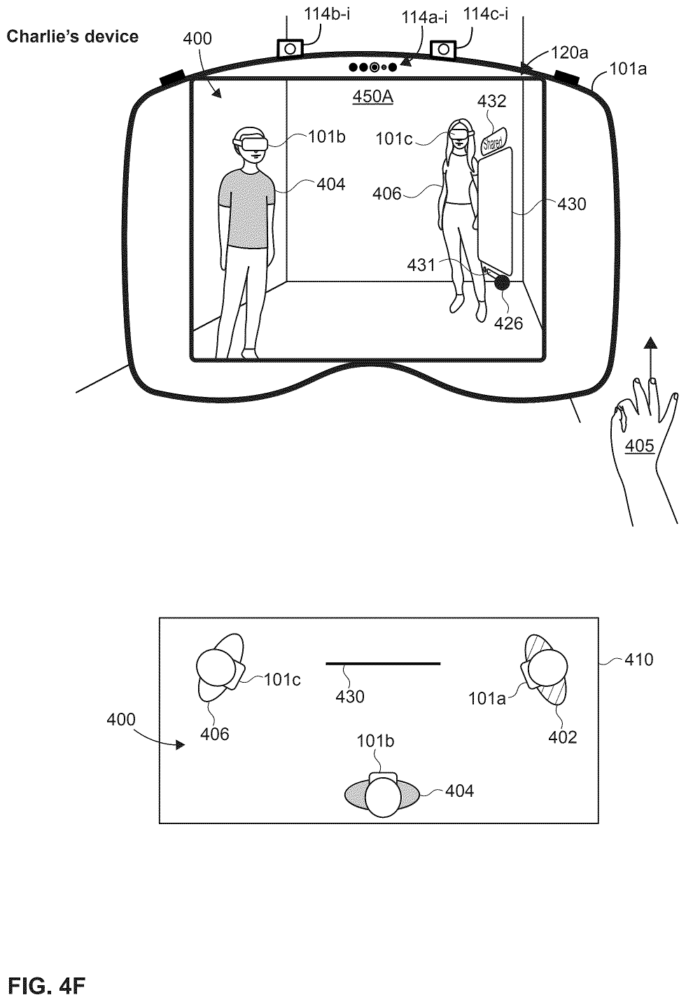

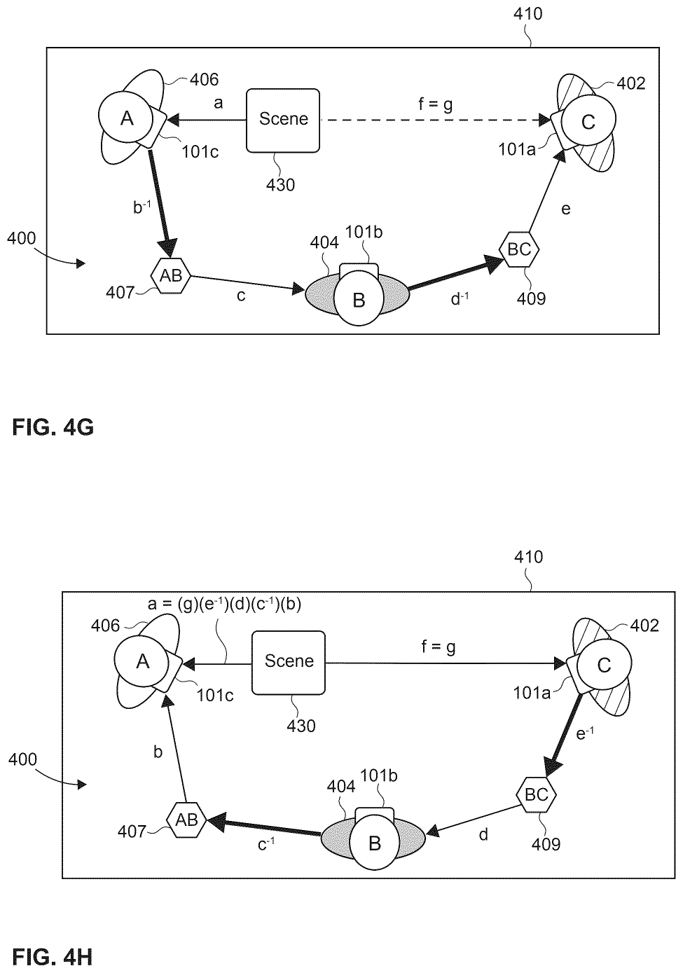

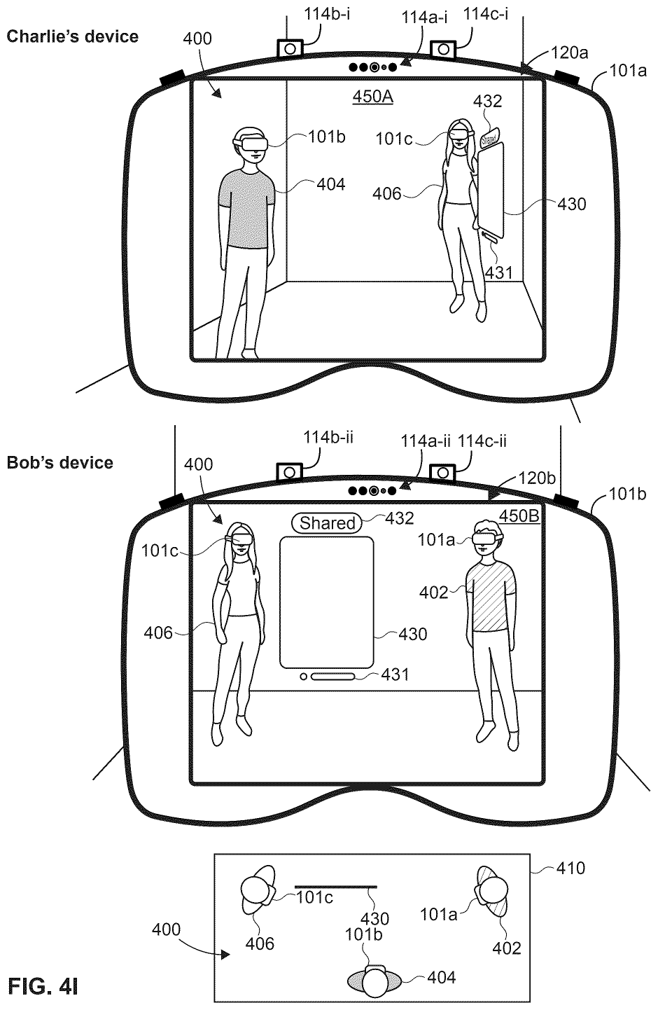

FIGS. 4A-4I illustrate examples of determining a local shared origin in a physical environment according to which shared content is displayed in a three-dimensional environment within a multi-user communication session according to some examples of the disclosure. In some examples, a first electronic device 101a may present, via display 120a, a three-dimensional environment 450A, and a second electronic device 101b may present, via display 120b, a three-dimensional environment 450B. The first electronic device 101a and the second electronic device 101b may be similar to electronic device 101 or electronic devices 260/270, and/or may be a head mountable system/device and/or projection-based system/device (including a hologram-based system/device) configured to generate and present a three-dimensional environment, such as, for example, heads-up displays (HUDs), head mounted displays (HMDs), windows having integrated display capability, or displays formed as lenses designed to be placed on a person's eyes (e.g., similar to contact lenses), respectively. In the example of FIGS. 4A-4I, a first user 402 (e.g., Charlie) is optionally wearing the first electronic device 101a, as shown in overhead view 410, and a second user 404 (e.g., Bob) is optionally wearing the second electronic device 101b, such that the three-dimensional environments 450A/450B can be defined by X, Y and Z axes as viewed from a perspective of the electronic devices (e.g., a viewpoint associated with the users of the electronic devices 101a/101b).

In FIG. 4A, as indicated in overhead view 410, the first electronic device 101a, the second electronic device 101b, and third electronic device 101c are collocated in physical environment 400. For example, the first electronic device 101a, the second electronic device 101b, and the third electronic device 101c are all located in a same physical room. In some examples, the determination that the first electronic device 101a, the second electronic device 101b, and the third electronic device 101c are collocated in the physical environment 400 is based on a distance between the first electronic device 101a, the second electronic device 101b, and the third electronic device 101c. For example, in FIG. 4A, the first electronic device 101a, the second electronic device 101b, and the third electronic device 101c are collocated in the physical environment 400 because the first electronic device 101a is within a threshold distance (e.g., 0.1, 0.5, 1, 2, 3, 5, 10, 15, 20, etc. meters) of each of the second electronic device 101b and the third electronic device 101c. In some examples, the determination that the first electronic device 101a, the second electronic device 101b, and the third electronic device 101c are collocated in the physical environment 400 is based on communication between the first electronic device 101a, the second electronic device 101b, and the third electronic device 101c. For example, in FIG. 4A, the first electronic device 101a, the second electronic device 101b, and the third electronic device 101c are configured to communicate (e.g., wirelessly, such as via Bluetooth, Wi-Fi, or a server (e.g., wireless communications terminal)). In some examples, the first electronic device 101a, the second electronic device 101b, and the third electronic device 101c are connected to a same wireless network in the physical environment 400. In some examples, the determination that the first electronic device 101a, the second electronic device 101b, and the third electronic device 101c are collocated in the physical environment 400 is based on a strength of a wireless signal transmitted between the electronic devices 101a/101b/101c. For example, in FIG. 4A, the first electronic device 101a, the second electronic device 101b, and the third electronic device 101c are collocated in the physical environment 400 because a strength of a Bluetooth signal (or other wireless signal) transmitted between the electronic devices 101a/101b/101c is greater than a threshold strength. In some examples, the determination that the first electronic device 101a, the second electronic device 101b, and the third electronic device 101c are collocated in the physical environment 400 is based on visual detection of the electronic devices 101a/101b/101c in the physical environment 400. For example, as shown in FIG. 4A, the second electronic device 101b and the third electronic device 101c are positioned in a field of view of the first electronic device 101a (e.g., because the second user 404 and the third user 406 are standing in the field of view of the first electronic device 101a), which enables the first electronic device 101a to visually detect (e.g., identify or scan, such as via object detection/recognition or other image processing techniques) the second electronic device 101b and the third electronic device 101c (e.g., in one or more images captured by the first electronic device 101a, such as via external image sensors 114b-i and 114c-i). Similarly, as shown in FIG. 4A, the first electronic device 101a and the third electronic device 101c are optionally positioned in a field of view of the second electronic device 101b (e.g., because the first user 402 and the third user 406 are standing in the field of view of the second electronic device 101b), which enables the second electronic device 101b to visually detect the first electronic device 101a and the third electronic device 101c (e.g., in one or more images captured by the second electronic device 101b, such as via external image sensors 114b-ii and 114c-ii).

In some examples, the three-dimensional environments 450A/450B include captured portions of the physical environment 400 in which the electronic devices 101a/101b are located. For example, because the first electronic device 101a and the second electronic device 101b are collocated in the physical environment 400, the three-dimensional environments 450A and 450B include the walls, floor, and/or ceiling (e.g., a representation of the walls, floor, and/or ceiling) of the room, but from the unique viewpoints of the first electronic device 101a and the second electronic device 101b, as shown in FIG. 4A. In some examples, the representations can include portions of the physical environment 400 viewed through a transparent or translucent display of the electronic devices 101a and 101b. In some examples, the three-dimensional environments 450A/450B have one or more characteristics of the three-dimensional environments 350A/350B described above with reference to FIG. 3.

Additionally, in some examples, as similarly described herein, the electronic devices 101a and 101b are configured to display virtual content in the three-dimensional environments 450A/450B. For example, as shown in FIG. 4A, the second electronic device 101b is displaying virtual object 430 in the three-dimensional environment 450B. In some examples, the virtual object 430 is associated with a respective application running on the second electronic device 101b, such as a media player application, a web-browsing application, a music player application, a virtual video game application, a document viewing application, etc. For example, the virtual object 430 is or includes content, such as one or more user interfaces, from the respective application running on the second electronic device 101b. In some examples, as indicated by pill 432 that is associated with the virtual object 430, the virtual object 430 corresponds to a private object within the multi-user communication session. For example, the content of the virtual object 430 is private to the second user 404 at the second electronic device 101b, such that, as illustrated in FIG. 4A, the virtual object 430 and/or the content of the virtual object 430 is visible to and/or interactive to the second user 404, without being visible to and/or interactive to the first user 402 and the third user 406 at their respective electronic devices. In some examples, as described in more detail below, the pill 432 is selectable to initiate a process for sharing the content of the virtual object 430 with other users in the multi-user communication session, such as the first user 402 and/or the third user 406. Additionally, in some examples, the virtual object 430 is displayed with and/or includes a grabber or handle bar 431. In some examples, as described in more detail later, the grabber bar 431 is selectable to initiate movement of the virtual object 430 in the three-dimensional environment 450B relative to the viewpoint of the second electronic device 101b.

In FIG. 4A, the second electronic device 101b detects an input corresponding to a request to share the content of the virtual object 430 in the multi-user communication session. For example, as shown in FIG. 4A, the second electronic device 101b detects a selection of the pill 432 that is associated with the virtual object 430 in the three-dimensional environment 450B, such as via an air pinch gesture performed by hand 405 of the second user 404, optionally while gaze 426 of the second user 404 is directed to the pill 432. It should be understood that additional and/or alternative forms of input are possible, such as an air tap gesture, a gaze dwell, a verbal command, etc., corresponding to selection of the pill 432 and/or a request to share the virtual object 430 in the multi-user communication session.

In some examples, as shown in FIG. 4B, in response to detecting the selection of the pill 432, the second electronic device 101b displays menu element 435 in the three-dimensional environment 450B. For example, as shown in FIG. 4B, the second electronic device 101b displays the menu element 435 overlaid on and/or in front of the virtual object 430 from the viewpoint of the second electronic device 101b in the three-dimensional environment 450B. In some examples, the menu element 435 includes one or more options for selecting/designating one or more recipients of the sharing of the content of the virtual object 430 in the multi-user communication session. For example, as shown in FIG. 4B, the menu element 435 includes a plurality of options for designating the first user 402 (e.g., User 1) as a recipient, the third user 406 (e.g., User 3) as the recipient, and/or both the first user 402 and the third user 406 as the recipients (e.g., Everyone).

In FIG. 4B, while displaying the menu element 435 in the three-dimensional environment 450B, the second electronic device 101b detects an input corresponding to a selection of option 436 in the menu element 435. For example, as shown in FIG. 4B, the second electronic device 101b detects an air pinch gesture performed by the hand 405, optionally while the gaze 426 is directed to the option 436 in the menu element 435 in the three-dimensional environment 450B. In some examples, as mentioned above, the selection of the option 436 corresponds to a request to designate both the first user 402 and the third user 406 as recipients of the sharing of the content of the virtual object 430 in the multi-user communication session.

In some examples, in FIG. 4C, when the request to share the virtual object 430 in the multi-user communication session is detected by the second electronic device 101b, the first electronic device 101a has a synchronized spatial understanding with the second electronic device 101b and the second electronic device 101b has a synchronized spatial understanding with the third electronic device 101c, but the first electronic device 101a does not have a synchronized spatial understanding with the third electronic device 101c. Accordingly, the first electronic device 101a and the third electronic device 101c are unable to display the virtual object 430 at a location in physical environment 400 that is synchronized to (e.g., known to and agreed upon by) both electronic devices 101a and 101c, and would thus be the same location at which the second electronic device 101b displays the virtual object 430. In some examples, as described herein, the electronic devices 101a/101b/101c need coordinate and agree upon a same location in the physical environment 400 to facilitate and maintain spatial truth within the multi-user communication session relative to the virtual object 430. For example, when the virtual object 430 is shared with the first electronic device 101a and the third electronic device 101c, the virtual object 430 need be displayed at the same location in the physical environment 400 for each of the electronic devices 101a/101b/101c to enable synchronized interaction with the virtual object 430 (e.g., movement of the virtual object 430, rotation of the virtual object 430, resizing of the virtual object 430, updating display of the content of the virtual object 430, etc.) in the multi-user communication session. Accordingly, in some examples, when the second electronic device 101b detects the request to share the content of the virtual object 430 with the first user 402 at the first electronic device 101a and the third user 406 at the third electronic device 101c, the electronic devices 101a/101b/101c initiate a process to determine a local shared origin in the physical environment 400 according to which the virtual object 430 is displayed at the electronic devices 101a/101b/101c. For example, in FIG. 4C, the first electronic device 101a, the second electronic device 101b, and the third electronic device 101c initiate a process to determine a placement location for the virtual object 430 within a shared coordinate space/system of the shared three-dimensional environment of the multi-user communication session.

In some examples, determining the local shared origin in the physical environment 400 according to which the virtual object 430 is displayed at each of the electronic device 101a/101b/101c is based on local private origins (e.g., previously) established between pairs of electronic devices in the multi-user communication session. For example, in FIG. 4C, as alluded to above, the second electronic device 101b and the third electronic device 101c share a local private origin 407 in the physical environment 400 according to which content that is shared between the second electronic device 101b and the third electronic device 101c is displayed at the electronic devices 101b and 101c. As an example, if, in FIG. 4B, the second electronic device 101b detected input provided by the second user 404 for sharing the content of the virtual object 430 with only the third user 406, the second electronic device 101b and the third electronic device 101c would display the virtual object 430 at a location in their respective three-dimensional environments that is relative to the local private origin 407. Similarly, in some examples, as shown in FIG. 4C, the second electronic device 101b and the first electronic device 101a share a local private origin 409 in the physical environment 400 according to which content that is shared between the second electronic device 101b and the first electronic device 101a is displayed at the electronic devices 101b and 101a. For example, if, in FIG. 4B, the second electronic device 101b alternatively detected input provided by the second user 404 for sharing the content of the virtual object 430 with only the first user 402, the second electronic device 101b and the first electronic device 101a would display the virtual object 430 at a location in their respective three-dimensional environments 450B/450A that is relative to the local private origin 409. It should be understood that the local private origins 407/409 are optionally not displayed in and/or visible in the shared three-dimensional environment.

In some examples, as illustrated in the overhead view 410 in FIG. 4C, the first electronic device 101a has a first pose relative to the local private origin 409 in the physical environment 400, represented by transform “e”. For example, in FIG. 4C, the first electronic device 101a is positioned at a first location and/or has a first orientation in the physical environment 400 relative to the local private origin 409 (e.g., based on a location and/or an orientation of the first user 402 in the physical environment 400). Similarly, in FIG. 4C, the second electronic device 101b has a second pose relative to the local private origin 409, represented by transform “d”, and relative to the local private origin 407, represented by transform “c”. For example, the second electronic device 101b is positioned at a second location and/or has a second orientation in the physical environment 400 relative to the local private origins 409/407 (e.g., based on a location and/or an orientation of the second user 404 in the physical environment 400). Additionally, in some examples, as illustrated in the overhead view 410 in FIG. 4C, the third electronic device 101c has a third pose relative to the local private origin 407 in the physical environment 400, represented by transform “b”. For example, in FIG. 4C, the third electronic device 101c is positioned at a third location and/or has a third orientation in the physical environment 400 relative to the local private origin 407 (e.g., based on a location and/or an orientation of the third user 406 in the physical environment 400).

In some examples, the pose of a respective electronic device is known to another electronic device in the multi-user communication session in accordance with a determination that the electronic devices share a local origin in the physical environment 400. For example, in FIG. 4C, the third pose of the third electronic device 101c relative to the local private origin 407 is known to the second electronic device 101b because the third electronic device 101c and the second electronic device 101b share a coordinate space/system centered on (e.g., defined according to) the local private origin 407 (e.g., the third electronic device 101c and the second electronic device 101b experience spatial truth within the multi-user communication session). As another example, in FIG. 4C, the first pose of the first electronic device 101a relative to the local private origin 409 is known to the second electronic device 101b because the first electronic device 101a and the second electronic device 101b share a coordinate space/system centered on (e.g., defined according to) the local private origin 409 in the physical environment 400 (e.g., the first electronic device 101a and the second electronic device 101b experience spatial truth within the multi-user communication session). Further, the second pose of the second electronic device 101b relative to the local private origins 407/409 is known to the third electronic device 101c and the first electronic device 101a, respectively, as similarly discussed above. However, as illustrated in the overhead view 410 in FIG. 4C and as similarly discussed above, because the first electronic device 101a and the third electronic device 101c do not share a local private origin in the physical environment 400, pose data associated with the third electronic device 101c is not known to the first electronic device 101a and pose data associated with the first electronic device 101a is not known to the third electronic device 101c.

In some examples, the local private origins 407/409 were established by the respective pairs of electronic devices prior to the second electronic device 101b detecting the input discussed above for sharing the virtual object 430 in the multi-user communication session. For example, the second electronic device 101b and the third electronic device 101c established the local private origin 407 prior to the first electronic device 101a joining the multi-user communication session with the second electronic device 101b and the third electronic device 101c. As another example, the local private origin 407 corresponds to a prior origin in the physical environment 400 that has been cached (e.g., stored in memory) by the second electronic device 101b and the third electronic device 101c according to which content was displayed in a prior multi-user communication session that included the second electronic device 101b and the third electronic device 101c (e.g., without including the first electronic device 101a). Similarly, in some examples, the second electronic device 101b and the first electronic device 101a established the local private origin 409 prior to the third electronic device 101c joining the multi-user communication session with the second electronic device 101b and the first electronic device 101a. Additionally or alternatively, in some examples, the local private origin 409 corresponds to a prior origin in the physical environment 400 that has been cached (e.g., stored in memory) by the second electronic device 101b and the first electronic device 101a according to which content was displayed in a prior multi-user communication session that included the second electronic device 101b and the first electronic device 101a (e.g., without including the third electronic device 101c). In some examples, the local private origins 407/409 correspond to physical locations in the physical environment 400. In some examples, the local private origins 407/409 correspond to physical objects in the physical environment 400. For example, the local private origins 407/409 correspond to surfaces on physical tables, desks, chairs, shelves, displays, screens, etc. in the physical environment 400.

In some examples, as alluded to above, the first electronic device 101a and the third electronic device 101c do not share and/or have not previously established a local private origin in the physical environment 400 (e.g., the first electronic device 101a is not currently experiencing spatial truth with the third electronic device 101c in the multi-user communication session). For example, the first electronic device 101a and the third electronic device 101c have never been in a multi-user communication session together prior to the current multi-user communication session that includes the first electronic device 101a, the second electronic device 101b, and the third electronic device 101c. Additionally or alternatively, in some examples, the first electronic device 101a and the third electronic device 101c have never been in a multi-user communication session together in the particular physical environment 400.

In some examples, as illustrated in the overhead view 410 in FIG. 4C, the local shared origin in the physical environment 400, from the perspective of the first user 402 at the first electronic device 101a, is represented by transform “f”. For example, the transform “f” dictates, to the first electronic device 101a, a pose of the virtual object 430 (e.g., labeled “Scene” in the overhead view 410) —namely a position and/or an orientation of the virtual object 430 in the three-dimensional environment 450A presented at the first electronic device 101a. In FIG. 4C, though the determination of the local shared origin is illustrated and described below in terms of the placement location of the virtual object 430, the local shared origin optionally corresponds to a location in the physical environment 400 that is different from the placement location of the virtual object 430 in the overhead view 410.

In some examples, as illustrated in the overhead view 410 in FIG. 4D, the local shared origin (e.g., and thus the placement location of the virtual object 430) in the physical environment 400 is determined by coordinating the local private origins 407/409 in the physical environment. For example, as indicated in the overhead view 410, the placement location of the virtual object 430 in the physical environment 400, with respect to the first electronic device 101a, is determined by performing a transform computation (e.g., matrix multiplication of the relative poses of the electronic devices). In some examples, the second electronic device 101b and the third electronic device 101c provide pose data that is relative to the local private origins 407/409 to the first electronic device 101a, which enables the first electronic device 101a to perform the transform computation for “f”. Particularly, in FIG. 4D, because the third electronic device 101c is already synchronized to a shared coordinate space with the second electronic device 101b via the local private origin 407, the third electronic device 101c is aware of the placement location of the virtual object 430 in the physical environment 400, as represented by transform “a” in the overhead view 410. Accordingly, the third electronic device 101c transmits, to the first electronic device 101a (e.g., directly or indirectly via a server), data including the transform “a” that indicates the placement location of the virtual object 430 relative to the third electronic device 101c in the physical environment 400. Similarly, the first electronic device 101a receives and/or obtains data including an inverse of transform “b” (e.g., “b⁻¹” in FIG. 4D), which indicates the pose of the third electronic device 101c relative to the local private origin 407, data including transform “c” which indicates the location of the local private origin 407 in the physical environment 400 relative to the second electronic device 101b, data including an inverse of transform “d” (e.g., “d⁻¹” in FIG. 4D) which indicates the pose of the second electronic device 101b relative to the local private origin 409, and data including the transform “e” which indicates the location of the local private origin 407 in the physical environment 400 relative to the first electronic device 101a. In computing the transform “f” in FIG. 4D, the first electronic device 101a determines the placement location for the virtual object 430 in the three-dimensional environment 450A presented at the first electronic device 101a, which corresponds to the same location in the physical environment 400 that is known to the second electronic device 101b and the third electronic device 101c. In this way, spatial truth is thus achieved for all users in the multi-user communication session, enabling the virtual object 430 to be positioned at a same location relative to the local shared origin in the physical environment 400, as illustrated in FIG. 4E.

It should be understood that a similar approach is optionally conducted by the third electronic device 101c to synchronize the understanding of the position and orientation of the first electronic device 101a in the physical environment 400. The above approach enables the first electronic device 101a and the third electronic device 101c to determine the true (e.g., most accurate and/or more accurate) transforms (e.g., position and orientation) of the other electronic device in the physical environment 400, thereby enabling the first electronic device 101a and the third electronic device 101c to coordinate the local shared origin in the physical environment 400 with the second electronic device 101b for the coordinated display of the virtual object 430, as one benefit.

As shown in FIG. 4E, when the virtual object 430 is displayed at the placement location relative to the local shared origin in the physical environment 400, the content of the virtual object 430 is visible to and/or interactive to the first user 402, the second user 404, and the third user 406 via their respective electronic devices. For example, as indicated by the pill 432 associated with the virtual object 430, the virtual object 430 is shared in the multi-user communication session (e.g., the virtual object 430 corresponds to a shared object as previously discussed herein).

In some examples, if a new collocated user (e.g., a fourth user of a fourth electronic device) joins the multi-user communication session that includes the first user 402, the second user 404, and the third user 406, the electronic device associated with the new user (e.g., the fourth electronic device) may sync to the local shared origin in the physical environment 400 previously coordinated by the electronic devices 101a/101b/101c in the multi-user communication session (e.g., and the display of the virtual object 430 is therefore maintained at the same location and/or orientation relative to the local shared origin as illustrated in FIG. 4E). Alternatively, in some examples, the first electronic device 101a, the second electronic device 101b, the third electronic device 101c, and the new fourth electronic device in the multi-user communication session coordinate to select a new/updated local shared origin in the physical environment 400, optionally by conducting a similar approach as above (e.g., utilizing the origins already known in the physical environment 400) to synchronize the understanding of the position and orientation of the fourth electronic device in the physical environment 400.

Further interactions with the virtual object 430, such as movement and/or rotation of the virtual object 430, performed in response to user input and/or the display of additional or alternative shared virtual objects in the shared three-dimensional environment are therefore also conducted using the local shared origin as a reference, enabling the first user 402, the second user 404, and the third user 406 to experience spatial truth within the multi-user communication session, which advantageously facilitates improved user experience and user perception of the virtual content, as discussed below.

In FIG. 4F, while displaying the virtual object 430 in the three-dimensional environment 450A, the first electronic device 101a detects an input corresponding to a request to move the virtual object 430 in the three-dimensional environment 450A from the viewpoint of the first electronic device 101a. For example, as shown in FIG. 4F, the first electronic device 101a detects an air pinch and drag gesture performed by hand 405 of the first user 402, optionally while the gaze 426 of the first user 402 is directed to grabber bar 431 in the three-dimensional environment 450A. In some examples, as indicated in FIG. 4F, the movement of the hand 405 corresponds to a request to move the virtual object 430 away from the viewpoint of the first electronic device 101a in the three-dimensional environment 450A.

In some examples, in response to detecting the input provided by the hand 405, the first electronic device 101a moves the virtual object 430 in the three-dimensional environment 450A above in accordance with the movement of the hand 405. For example, as illustrated in the overhead view 410 in FIG. 4G, the first electronic device 101a moves the virtual object 430 (e.g., “Scene”) away from the viewpoint of the first electronic device 101a, such that the virtual object 430 is located a greater distance from the viewpoint of the first electronic device 101a in the physical environment 400 than in FIG. 4F. In some examples, the movement of the virtual object 430 in response to the input provided by the first user 402 corresponds to an event that causes the value of the transform “f” to be updated. For example, as indicated by updated value “g” in FIG. 4G, the movement of the virtual object 430 causes the virtual object 430 to have an updated pose in the physical environment (e.g., an updated position and/or an updated orientation) relative to the viewpoint of the first electronic device 101a.

In some examples, because the virtual object 430 is a shared object in the multi-user communication session, the movement of the virtual object 430 at the first electronic device 101a also correspondingly causes the virtual object 430 to be moved at the second electronic device 101b and the third electronic device 101c (e.g., based on the direction and/or magnitude of the movement of the virtual object 430 at the first electronic device 101a). In some examples, as alluded to above, the second electronic device 101b and the third electronic device 101c move the virtual object 430 relative to the local shared origin in the physical environment 400. Particularly, in some examples, the second electronic device 101b and/or the third electronic device 101c locally update the transforms of the overhead view 410, which enables the virtual object 430 to be repositioned in the same manner for the second user 404 and the third user 406 as the first user 402 at the first electronic device 101a. For example, as illustrated in the overhead view 410 in FIG. 4H, the third electronic device 101c determines the updated placement location of the virtual object 430 (e.g., updated based on the movement of the virtual object 430 at the first electronic device 101a) by updating the transform “a” which corresponds to (e.g., is equal to) a transform computation of the individual transforms “f” (e.g., described above, equal to “g” in FIG. 4H), “e⁻¹”, “d”, “c⁻¹”, and “b”. In the example of FIG. 4H, the updated transform “f” includes an indication of the updated pose (e.g., updated location and/orientation) of the virtual object 430 relative to the first electronic device 101a in the physical environment 400. For example, determining and/or obtaining the updated transform “f” provides the third electronic device 101c with an indication of an updated distance between the first electronic device 101a and the updated location of the virtual object 430 in the physical environment 400. As described previously above, when the local shared origin is initially determined for the multi-user communication session, thereby enabling the users 402/404/406 to experience spatial truth at their respective electronic devices, the pose data associated with the first electronic device 101a relative to the local shared origin is shared with the third electronic device 101c, thereby enabling the third electronic device 101c to determine a distance between the first electronic device 101a and the virtual object 430 in the physical environment 400 (e.g., prior to the movement of the virtual object 430). Accordingly, the updated placement location of the virtual object 430 is determined by performing a similar transform computation as described above, as indicated in the overhead view 410 in FIG. 4H. For example, the third electronic device 101c performs the transform computation based on data provided by and/or obtained from the first electronic device 101a and/or the second electronic device 101b, as similarly discussed above, such as the transform “e⁻¹” which indicates the pose of the first electronic device 101a relative to the local private origin 409, the transform “d” which indicates the location of the local private origin 409 relative to the second electronic device 101b, the transform “c⁻¹” which indicates the pose of the second electronic device 101b relative to the local private origin 407, and the transform “b” which indicates the location of the local private origin 407 relative to the third electronic device 101c. It should be understood that a similar approach is optionally conducted by the second electronic device 101b to synchronize the understanding of the updated position and/or orientation of the virtual object 430 in the physical environment 400.

In some examples, as shown in FIG. 4I, when the updated placement location is synchronized across the electronic devices 101a/101b/101c, the display of the virtual object 430 is updated in the shared three-dimensional environment. For example, as shown in FIG. 4I, the first electronic device 101a moves the virtual object 430 away from the viewpoint of the first electronic device 101a in the three-dimensional environment 450A (e.g., and toward the third user 406 relative to the viewpoint of the first electronic device 101a) and the second electronic device 101b moves the virtual object 430 leftward in the three-dimensional environment 450B relative to the viewpoint of the second electronic device 101b based on the movement input detected by the first electronic device 101a.

Attention is now directed toward alternative or additional examples of facilitating determination of a local shared origin in a physical environment according to which shared content is displayed in a three-dimensional environment within a multi-user communication session that includes collocated users.

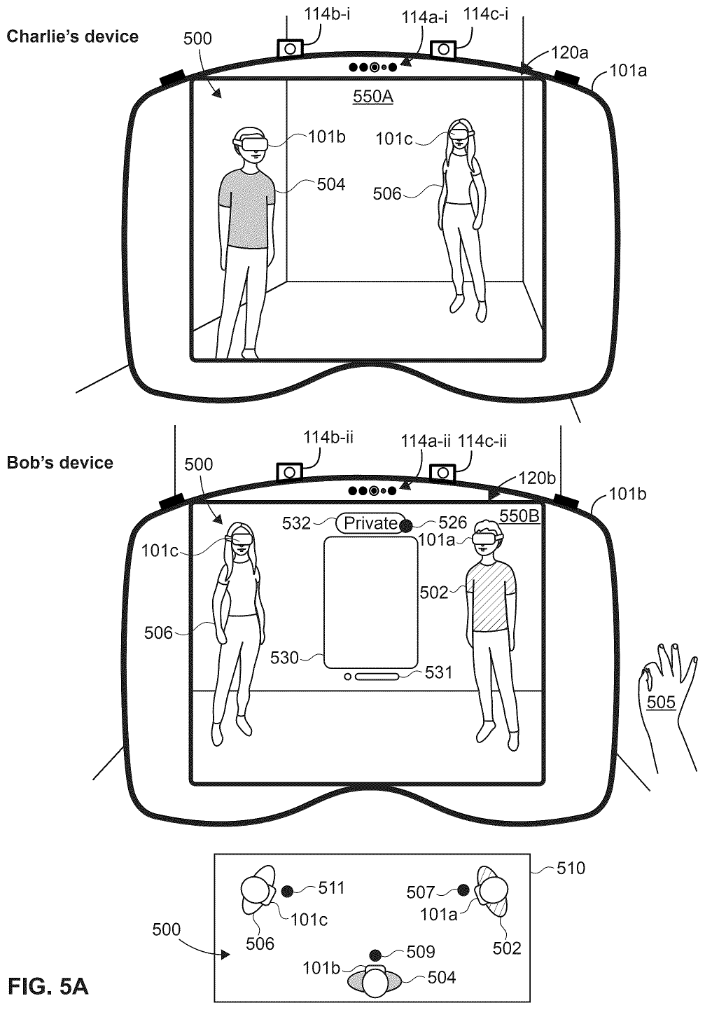

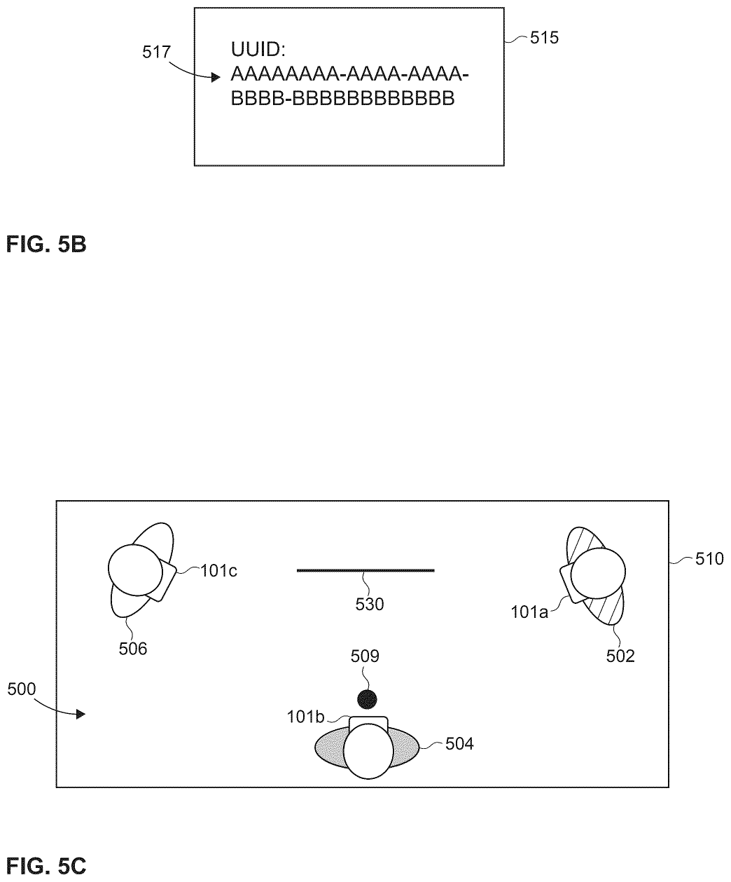

FIGS. 5A-5C illustrate examples of determining a local shared origin in a physical environment according to which shared content is displayed in a three-dimensional environment within a multi-user communication session according to some examples of the disclosure. In some examples, the multi-user communication session includes a first user 502 of a first electronic device 101a, a second user 504 of a second electronic device 101b, and a third user 506 of a third electronic device 101c. In some examples, the first user 502, the second user 504, and the third user 506 correspond to first user 402, second user 404, and third user 406, respectively, of FIGS. 4A-4I above. In some examples, as similarly described above, the first user 502 (e.g., and the first electronic device 101a), the second user 504 (e.g., and the second electronic device 101b), and the third user 506 (e.g., and the third electronic device 101c) are collocated in physical environment 500.

As shown in FIG. 5A, the first electronic device 101a is presenting (e.g., via display 120a) three-dimensional environment 550A. In FIG. 5A, as similarly discussed above, the three-dimensional environment 550A includes representations (e.g., passthrough representations or computer-generated representations) of the physical environment 500 in which the first electronic device 101a, the second electronic device 101b, and the third electronic device 101c are located, but from the viewpoint of the first electronic device 101a in the physical environment 500. For example, as shown in FIG. 5A, the three-dimensional environment 550A presented using the first electronic device 101a includes representations of the walls, floor, and/or ceiling of the physical environment 500 from the unique viewpoint of the first electronic device 101a. Additionally, in some examples, as similarly discussed above, the three-dimensional environment 550A includes representations (e.g., passthrough representations or computer-generated representations) of the second user 504 (e.g., and the second electronic device 101b) and the third user 506 (e.g., and the third electronic device 101c) that are visible in the field of view of the first electronic device 101a in the physical environment 500. For example, because the second user 504 and the third user 506 are collocated with the first user 502 in the physical environment 500, the second user 504 and the third user 506 that are visible in the field of view of the first electronic device 101a are represented by their physical bodies in the three-dimensional environment 550A within the multi-user communication session (e.g., rather than via virtual representations, such as avatars). In some examples, the three-dimensional environment 550A has one or more characteristics of three-dimensional environment 450A discussed above.

Additionally, in some examples, shown in FIG. 5A, the second electronic device 101b is presenting (e.g., via display 120b) three-dimensional environment 550B. In FIG. 5A, as similarly discussed above, the three-dimensional environment 550B includes representations (e.g., passthrough representations or computer-generated representations) of the physical environment 500 in which the first electronic device 101a, the second electronic device 101b, and the third electronic device 101c are located, but from the viewpoint of the second electronic device 101b in the physical environment 500. For example, as shown in FIG. 5A, the three-dimensional environment 550B presented using the second electronic device 101b includes representations of the walls, floor, and/or ceiling of the physical environment 500 from the unique viewpoint of the second electronic device 101b. Additionally, in some examples, as similarly discussed above, the three-dimensional environment 550B includes representations (e.g., passthrough representations or computer-generated representations) of the first user 502 (e.g., and the first electronic device 101a) and the third user 506 (e.g., and the third electronic device 101c) that are visible in the field of view of the second electronic device 101b in the physical environment 500. For example, because the first user 502 and the third user 506 are collocated with the second user 504 in the physical environment 500, the first user 502 and the third user 506 that are visible in the field of view of the second electronic device 101b are represented by their physical bodies in the three-dimensional environment 550B within the multi-user communication session (e.g., rather than via virtual representations, such as avatars). In some examples, the three-dimensional environment 550B has one or more characteristics of three-dimensional environment 450B discussed above.

In some examples, as shown in FIG. 5A and as similarly discussed above, the second electronic device 101b is displaying virtual object 530 in the three-dimensional environment 550B. In some examples, as indicated by pill 532 in FIG. 5A, the virtual object 530 corresponds to a private object in the multi-user communication session. For example, as similarly discussed above, the content of the virtual object 530 is visible to and/or interactive to the second user 504 at the second electronic device 101b, without being visible to and/or interactive to the first user 502 and the third user 506 at their respective electronic devices. In some examples, as shown in FIG. 5A, the virtual object 530 includes and/or is displayed with grabber or handle bar 531 that is selectable to initiate movement of the virtual object 530 within the three-dimensional environment 550B relative to the viewpoint of the second electronic device 101b. In some examples, as similarly discussed above, the pill 532 is selectable to initiate a process to share the content of the virtual object 530 in the multi-user communication session. In some examples, the virtual object 530 corresponds to virtual object 430 described above.

In some examples, as illustrated in the overhead view 510 in FIG. 5A, each user in the multi-user communication session is associated with a local origin in the physical environment 500. For example, as shown in FIG. 5A, the first user 502 is associated with local origin 507, the second user 504 is associated with local origin 509, and the third user 506 is associated with local origin 511. In some examples, the local origins 507/509/511 are determined by the electronic devices 101a/101b/101c. For example, the local origin 507 in the physical environment 500 is determined by the first electronic device 101a, the local origin 509 is determined by the second electronic device 101b, and the local origin 511 is determined by the third electronic device 101c. In some examples, the local origins 507/509/511 correspond to (e.g., different) physical locations in the physical environment 500. In some examples, the local origins 507/509/511 correspond to (e.g., different) physical objects in the physical environment 500. For example, the local origins 507/509/511 correspond to surfaces of different physical objects in the physical environment 500, such as surfaces of desks, tables, chairs, shelves, displays, screens, devices, etc. In some examples, the local origins 507/509/511 are determined by the electronic devices 101a/101b/101c automatically (e.g., without user input) when the electronic devices 101a/101b/101c initially join the multi-user communication session. For example, the local origin 507 is located at a default position and/or a default distance from the first electronic device 101a in the physical environment 500, the local origin 509 is located at a default position and/or a default distance from the second electronic device 101b in the physical environment 500, and the local origin 511 is located at a default position and/or a default distance from the third electronic device 101c in the physical environment 500. In some examples, as similarly described above with reference to local origins in FIGS. 4A-4I, the local origins 507/509/511 in the physical environment 500 serve as center points and/or anchor points according to which a virtual coordinate space/system is defined at the electronic devices 101a/101b/101c (e.g., for the display of virtual content). For example, in FIG. 5A, because the virtual object 530 is private to the second user 504 in the multi-user communication session, the second electronic device 101b is displaying the virtual object 530 in the three-dimensional environment 550B relative to the local origin 509 that is associated with the second user 504 in the physical environment 500.

In FIG. 5A, the second electronic device 101b detects an input corresponding to a request to share the content of the virtual object 530 with other users in the multi-user communication session. For example, as shown in FIG. 5A, the second electronic device 101b detects an air pinch gesture provided by hand 505 of the second user 504 directed to the pill 532 in the three-dimensional environment 550B (e.g., while gaze 526 of the second user 504 is directed to the pill 532). In some examples, as similarly discussed above with reference to FIG. 4B, the input includes a selection/designation of one or more recipients of the sharing the content of the virtual object 530, such as the first user 502 and/or the third user 506, in the multi-user communication session (e.g., via a menu element similar to menu element 435 in FIG. 4B).

In some examples, when the second electronic device 101b detects the input above corresponding to the request to share the content of the virtual object 530 in the multi-user communication session, the first electronic device 101a, the second electronic device 101b, and the third electronic device 101c determine a local shared origin in the physical environment 500 according to which the virtual object 530 is to be displayed at the electronic devices 101a/101b/101c. For example, as similarly discussed above, the first electronic device 101a, the second electronic device 101b, and the third electronic device 101c display the virtual object 530 at a location and/or with an orientation in the shared three-dimensional environment that is relative to the same anchor in the physical environment 500. In some examples, as described below, the local shared origin in the physical environment 500 is selected from the local origins 507/509/511 that are associated with the users of the electronic devices 101a/101b/101c in the multi-user communication session.

In some examples, each user (e.g., each participant) in the multi-user communication session is associated with a universally unique identifier (UUID) that identifies a respective user to the other electronic devices in the multi-user communication session. In some examples, a respective UUID that is associated with a respective user is determined and/or generated by the electronic device associated with the respective user. In some examples, a respective UUID that is associated with a respective user is determined and/or generated by a host server (e.g., wireless communications terminal) of the multi-user communication session with which the electronic device associated with the respective user is associated. In some examples, the UUIDs of the first user 502, the second user 504, and the third user 506 are different from each other. In some examples, the UUIDs of the first user 502, the second user 504, and the third user 506 are configured to be exchanged between the first electronic device 101a, the second electronic device 101b, and the third electronic device 101c.

In some examples, as illustrated in glyph 515 in FIG. 5B, a respective UUID 517 comprises a (e.g., randomized) sequence of bits (e.g., of a predetermined and/or default length, such as 64, 128, 256, etc. bits). Additionally, in some examples, the respective UUID 517 represents the local origin that is associated with a respective user in the physical environment 500. For example, if the respective UUID 517 is associated with the first user 502 in FIG. 5A, the respective UUID 517 represents the local origin 507 in the physical environment 500. In some examples, the respective UUID 517 may be modified to include a communication session identifier and a participant identifier. For example, in the glyph 515 in FIG. 5B, the “A” bits of the respective UUID 517 (e.g., corresponding to a top number (e.g., upper half) of the bits) may represent and/or correspond to the communication session identifier (e.g., the current multi-user communication session that includes the users 502/504/506) and the “B” bits of the respective UUID 517 (e.g., corresponding to a bottom number (e.g., lower half) of the bits) may represent and/or correspond to the participant identifier of the respective user with which the respective UUID 517 is associated.

In some examples, when the first electronic device 101a, the second electronic device 101b, and the third electronic device 101c determine the local shared origin in the physical environment 500 for coordinating the display of the virtual object 530 within the multi-user communication session, the electronic devices 101a/101b/101c identify each other using the communication session identifier (e.g., the “A” bits of the respective UUID 517 described above). For example, as discussed above, the first user 502, the second user 504, and the third user 506 are each associated with a UUID that includes the same communication session identifier (e.g., because the users 502/504/506 are in the same multi-user communication session via their respective electronic devices). Accordingly, in some examples, if the physical environment 500 includes a fourth user of a fourth electronic device that was not participating in the same multi-user communication session as the electronic devices 101a/101b/101c, the UUID associated with the fourth user would include a different communication session identifier. In some examples, after the first electronic device 101a, the second electronic device 101b, and the third electronic device 101c identify each other as having the same communication session identifier, the electronic devices 101a/101b/101c determine which user is associated with a UUID that includes a participant identifier that satisfies one or more selection criteria, as discussed below. In some examples, following the determination of the participant identifier that satisfies the one or more selection criteria, the electronic devices 101a/101b/101c select the local shared origin to correspond to the local origin associated with the user associated with the selected participant identifier.

In some examples, satisfaction of the one or more selection criteria is based on a value associated with the participant identifier of each user in the multi-user communication session. For example, as described above, the participant identifier comprises a certain number of bits (e.g., the “B” bits of the respective UUID 517 in FIG. 5B) that collectively equate to a binary number. In some examples, the electronic devices 101a/101b/101c determine whether a respective participant identifier satisfies the one or more selection criteria by comparing the value (e.g., binary number) associated with the participant identifiers of the users 502/504/506. Particularly, in some examples, the participant identifier that has the lowest value of the participant identifiers associated with the first user 502, the second user 504, and the third user 506 is determined to satisfy the one or more selection criteria. Alternatively, in some examples, the participant identifier that has the highest value of the participant identifiers associated with the first user 502, the second user 504, and the third user 506 is determined to satisfy the one or more selection criteria. It should be understood that, in some examples, additional or alternative mathematical comparisons may be performed using the bits of the participant identifiers of the users in the multi-user communication session for the purposes of determining satisfaction of the one or more selection criteria.

In FIG. 5C, the first electronic device 101a, the second electronic device 101b, and the third electronic device 101c determine that the participant identifier associated with the second user 504 satisfies the one or more selection criteria above. For example, the first electronic device 101a, the second electronic device 101b, and the third electronic device 101c determine, based on an analysis of the UUIDs associated with the first user 502, the second user 504, and the third user 506, that the participant identifier of the second user 504 has the lowest value (e.g., lowest binary number) compared to those of the first user 502 and the third user 506. In some examples, as similarly mentioned above, in accordance with the determination that the participant identifier associated with the second user 504 satisfied the one or more selection criteria, the local shared origin in the physical environment 500 is selected to be and/or correspond to the local origin 509 in the physical environment 500. For example, as illustrated in the overhead view 510 in FIG. 5C, the local origin 509 is selected to be the local shared origin in the physical environment 500 according to which the virtual object 530 is displayed after being shared with the first user 502 and the third user 506 in the multi-user communication session. In some examples, as shown in FIG. 5C, when the content of the virtual object 530 is shared in the multi-user communication session, the virtual object 530 is displayed at each of the electronic devices 101a/101b/101c with a position and/or an orientation that is relative to the local origin 509 in the physical environment 500.

Accordingly, as outlined above, providing a method for effectively and efficiently determining a local shared origin in a physical environment according to which shared content is displayed in a shared three-dimensional environment within a multi-user communication session, without requiring the users in the multi-user communication session to provide input designating the local shared origin, helps simplify and/or reduce user interactions needed to share content within the multi-user communication session, as one benefit. Additionally, future interactions with the virtual object 530, such as movement and/or rotation of the virtual object 530, performed in response to user input and/or the display of additional or alternative shared virtual objects in the shared three-dimensional environment are therefore also conducted using the local shared origin as a reference, enabling the first user 502, the second user 504, and the third user 506 to experience spatial truth within the multi-user communication session, which facilitates improved user experience and user perception of the virtual content, as another benefit.

Additionally, in some examples, after the local shared origin is selected to be the local origin 509 that is associated with the second user 504 as shown in the overhead view 510 in FIG. 5C, the participant identifier of the UUID associated with the second user 504 may be cached/stored in memory, such as within a cloud-based memory, a memory of one or more of the electronic devices 101a/101b/101c, and external hard drive, and/or other forms of memory. In some examples, the storing of the participant identifier enables the local origin 509 in the physical environment 500 (e.g., which corresponds to the local shared origin in the physical environment 500 as discussed above) to be stored as well (e.g., because the UUID associated with the second user 504 represents the local origin 509 in the physical environment 500 as discussed above). In some examples, after the participant identifier of the second user 504 is stored, the participant identifier may be used to recall previously used origins in the physical environment 500 (e.g., such as the local origin 509) during facilitation of future multi-user communication sessions. For example, if the second user 504 of the second electronic device 101b joins a future multi-user communication with collocated users in the physical environment 500, including if the second user 504 leaves the current multi-user communication session in FIG. 5C and rejoins at a later time while the multi-user communication session is still active, the previous local shared origin (e.g., the local origin 509) would be used as the reference for displaying shared content within the multi-user communication session as similarly discussed above. Similarly, in some examples, if a new collocated user (e.g., a fourth user of a fourth electronic device) joins the multi-user communication session that includes the first user 502, the second user 504, and the third user 506, the electronic device associated with the new user (e.g., the fourth electronic device) may sync to the local shared origin (e.g., the local origin 509) in the physical environment 500 previously coordinated by the electronic devices 101a/101b/101c in the multi-user communication session (e.g., and the display of the virtual object 530 is therefore maintained at the same location and/or orientation relative to the local shared origin as illustrated in FIG. 5C). Additionally or alternatively, the previous local shared origin that is cashed in the memory in the manner discussed above may correspond to a private local origin in the physical environment 500 that is synchronized between pairs of electronic devices, such as local private origins 407/409 described above with reference to FIG. 4C.

It is understood that the examples shown and described herein are merely exemplary and that additional and/or alternative elements may be provided within the three-dimensional environment for facilitating sharing of content in multi-user communication sessions that include collocated users. It should be understood that the appearance, shape, form, and size of each of the various user interface elements and objects shown and described herein are exemplary and that alternative appearances, shapes, forms and/or sizes may be provided. For example, the virtual objects representative of user interfaces (e.g., virtual objects 430 and 530 and/or menu element 435) may be provided in an alternative shape than a rectangular shape, such as a circular shape, triangular shape, etc. In some examples, the various selectable affordances (e.g., option 436 and/or pills 432 and 532) described herein may be selected verbally via user verbal commands (e.g., “select option” or “select virtual object” verbal command). Additionally or alternatively, in some examples, the various options, user interface elements, control elements, etc. described herein may be selected and/or manipulated via user input received via one or more separate input devices in communication with the electronic device(s). For example, selection input may be received via physical input devices, such as a mouse, trackpad, keyboard, etc. in communication with the electronic device(s).

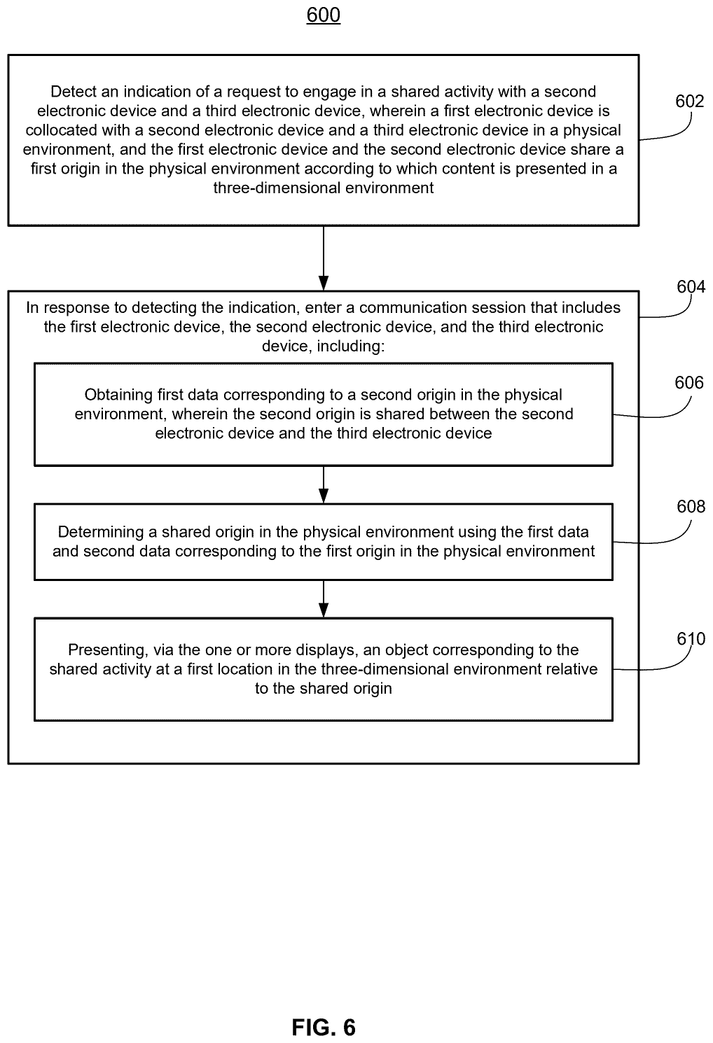

FIG. 6 illustrates a flow diagram illustrating an example process for determining a local shared origin in a physical environment according to which shared content is displayed in a three-dimensional environment within a multi-user communication session according to some examples of the disclosure. In some examples, process 600 begins at a first electronic device in communication with one or more displays and one or more input devices, wherein the first electronic device is collocated with a second electronic device and a third electronic device in a physical environment. In some examples, the first electronic device, the second electronic device, and the third electronic device are optionally a head-mounted display similar or corresponding to electronic devices 260 and 270 of FIG. 2 and/or electronic device 101 of FIG. 1. As shown in FIG. 6, in some examples, at 602, the first electronic device detects an indication of a request to engage in a shared activity with the second electronic device and the third electronic device, wherein the first electronic device and the second electronic device share a first origin in the physical environment according to which content is presented in a three-dimensional environment. For example, as illustrated in FIG. 4B, second electronic device 101b detects a selection of option 436 in menu element 435 provided by hand 405 corresponding to a request to share content of virtual object 430 with first electronic device 101a and third electronic device 101c. Additionally, in some examples, as illustrated in overhead view 410 in FIG. 4C, the first electronic device 101a shares local private origin 409 with the second electronic device 101b in physical environment 400.

In some examples, at 604, in response to detecting the indication, the first electronic device enters a communication session that includes the first electronic device, the second electronic device, and the third electronic device. For example, as described with reference to FIG. 4C, the second electronic device 101b initiates a process to share the content of the virtual object 430 with the first electronic device 101a and the third electronic device 101c. In some examples, at 606, the first electronic device obtains first data corresponding to a second origin in the physical environment, wherein the second origin is shared between the second electronic device and the third electronic device. For example, the first electronic device 101a receives data corresponding to local private origin 407 that is shared between the second electronic device 101b and the third electronic device 101c in the overhead view 410 in FIG. 4D.

In some examples, at 608, the first electronic device determines a shared origin in the physical environment using the first data and second data corresponding to the first origin in the physical environment. For example, as described with reference to FIG. 4D, the first electronic device 101a calculate transform “f” indicating a placement location for the virtual object 430 in the physical environment 400, thereby determining the local shared origin in the physical environment 400. In some examples, at 610, the first electronic device presents, via the one or more displays, an object corresponding to the shared activity at a first location in the three-dimensional environment relative to the shared origin. For example, as shown in FIG. 4E, the first electronic device 101a displays the virtual object 430 in three-dimensional environment 450A at the placement location indicated in the overhead view 410 in FIG. 4D.

It is understood that process 600 is an example and that more, fewer, or different operations can be performed in the same or in a different order. Additionally, the operations in process 600 described above are, optionally, implemented by running one or more functional modules in an information processing apparatus such as general-purpose processors (e.g., as described with respect to FIG. 2) or application specific chips, and/or by other components of FIG. 2.

Therefore, according to the above, some examples of the disclosure are directed to a method comprising, at a first electronic device in communication with one or more displays and one or more input devices, wherein the first electronic device is collocated with a second electronic device and a third electronic device in a physical environment: detecting an indication of a request to engage in a shared activity with the second electronic device and the third electronic device, wherein the first electronic device and the second electronic device share a first origin in the physical environment according to which content is presented in a three-dimensional environment; and in response to detecting the indication, entering a communication session that includes the first electronic device, the second electronic device, and the third electronic device, including: obtaining first data corresponding to a second origin in the physical environment, wherein the second origin is shared between the second electronic device and the third electronic device; determining a shared origin in the physical environment using the first data and second data corresponding to the first origin in the physical environment; and presenting, via the one or more displays, an object corresponding to the shared activity at a first location in the three-dimensional environment relative to the shared origin.

Additionally or alternatively, in some examples, the first origin in the physical environment corresponds to a first physical location in the physical environment, and the second origin in the physical environment corresponds to a second physical location, different from the first physical location, in the physical environment. Additionally or alternatively, in some examples, the first origin in the physical environment corresponds to a first physical object in the physical environment, and the second origin in the physical environment corresponds to a second physical object, different from the first physical object, in the physical environment. Additionally or alternatively, in some examples, the first origin in the physical environment is determined based on first respective data exchanged between the first electronic device and the second electronic device, the second origin in the physical environment is determined based on second respective data exchanged between the second electronic device and the third electronic device, and the first respective data is exchanged independently of the second respective data. Additionally or alternatively, in some examples, the first origin and the second origin are determined prior to the first electronic device detecting the indication of the request to engage in the shared activity with the second electronic device and the third electronic device. Additionally or alternatively, in some examples, determining the shared origin in the physical environment using the first data and the second data includes computing a product of at least a first transform associated with the first origin and a second transform associated with the second origin. Additionally or alternatively, in some examples, the second transform includes an indication of a location and/or an orientation of the third electronic device relative to the second origin in the physical environment. Additionally or alternatively, in some examples, the first transform includes an indication of a location and/or an orientation of the second electronic device relative to the first origin the physical environment.

Additionally or alternatively, in some examples, the method further comprises after presenting the object corresponding to the shared activity at the first location in the three-dimensional environment relative to the shared origin, transmitting, to the second electronic device and the third electronic device, third data corresponding to the shared origin in the physical environment. Additionally or alternatively, in some examples, the method further comprises: while presenting the object corresponding to the shared activity at the first location in the three-dimensional environment relative to the shared origin, detecting an indication of input corresponding to a request to move the object in the three-dimensional environment; and in response to detecting the indication, moving the object from the first location to a second location, different from the first location, relative to the shared origin in the three-dimensional environment based on the input. Additionally or alternatively, in some examples, the indication of input corresponds to input provided by a user of the second electronic device that is detected by the second electronic device, and the object is moved from the first location to the second location relative to the shared origin in the three-dimensional environment based on respective data provided by the second electronic device corresponding to movement of the object relative to the shared origin. Additionally or alternatively, in some examples, determining the shared origin in the physical environment using the first data and the second data includes synchronizing to a respective session identifier from a plurality of session identifiers associated with a user of the first electronic device, a user of the second electronic device, and a user of the third electronic device. Additionally or alternatively, in some examples, a first session identifier of the plurality of session identifiers includes first identification data corresponding to the communication session and second identification data corresponding to the user of the first electronic device, a second session identifier of the plurality of session identifiers includes the first identification data corresponding to the communication session and third identification data corresponding to the user of the second electronic device, and a third session identifier of the plurality of session identifiers includes the first identification data corresponding to the communication session and fourth identification data corresponding to the user of the third electronic device.

Additionally or alternatively, in some examples, in accordance with a determination that the first identification data satisfies one or more selection criteria, the shared origin corresponds to the first origin, and in accordance with a determination that the third identification data satisfies the one or more selection criteria, the shared origin corresponds to the second origin. Additionally or alternatively, in some examples, the one or more selection criteria are based on a value associated with respective identification data corresponding a user of a respective electronic device. Additionally or alternatively, in some examples, in accordance with a determination that the first origin corresponds to a previously coordinated shared origin in the physical environment, the shared origin corresponds to the first origin, and in accordance with a determination that the second origin corresponds to a previously coordinated shared origin in the physical environment, the shared origin corresponds to the second origin. Additionally or alternatively, in some examples, the method further comprises: while presenting the object corresponding to the shared activity at the first location in the three-dimensional environment relative to the shared origin, detecting an indication of a request to add a fourth electronic device to the communication session, wherein the fourth electronic device is collocated with the first electronic device, the second electronic device, and the third electronic device in the physical environment; and in response to detecting the indication, adding the fourth electronic device to the communication session that includes the first electronic device, the second electronic device, and the third electronic device, including maintaining display, via the one or more displays, of the object corresponding to the shared activity at the first location in the three-dimensional environment relative to the shared origin. Additionally or alternatively, in some examples, the method further comprises: while presenting the object corresponding to the shared activity at the first location in the three-dimensional environment relative to the shared origin, detecting an indication of a request to add a fourth electronic device to the communication session, wherein the fourth electronic device is collocated with the first electronic device, the second electronic device, and the third electronic device in the physical environment; and in response to detecting the indication, adding the fourth electronic device to the communication session that includes the first electronic device, the second electronic device, and the third electronic device, including obtaining third data corresponding to a third origin in the physical environment, wherein the second origin is shared between the fourth electronic device and the third electronic device, determining a second shared origin in the physical environment using the first data, the second data, and the third data, and updating display, via the one or more displays, of the object corresponding to the shared activity to be displayed at a second location, different from the first location, in the three-dimensional environment relative to the second shared origin.

Some examples of the disclosure are directed to an electronic device, comprising: one or more processors; memory; and one or more programs stored in the memory and configured to be executed by the one or more processors, the one or more programs including instructions for performing any of the above methods.

Some examples of the disclosure are directed to a non-transitory computer readable storage medium storing one or more programs, the one or more programs comprising instructions, which when executed by one or more processors of an electronic device, cause the electronic device to perform any of the above methods.

Some examples of the disclosure are directed to an electronic device, comprising one or more processors, memory, and means for performing any of the above methods.

Some examples of the disclosure are directed to an information processing apparatus for use in an electronic device, the information processing apparatus comprising means for performing any of the above methods.

The foregoing description, for purpose of explanation, has been described with reference to specific examples. However, the illustrative discussions above are not intended to be exhaustive or to limit the disclosure to the precise forms disclosed. Many modifications and variations are possible in view of the above teachings. The examples were chosen and described in order to best explain the principles of the disclosure and its practical applications, to thereby enable others skilled in the art to best use the disclosure and various described examples with various modifications as are suited to the particular use contemplated.

What is claimed is:

1. A method comprising:
at a first electronic device in communication with one or more displays and one or more input devices, wherein the first electronic device is collocated with a second electronic device and a third electronic device in a physical environment:
detecting an indication of a request to engage in a shared activity with the second electronic device and the third electronic device, wherein the first electronic device and the second electronic device share a first origin in the physical environment according to which content is presented in a three-dimensional environment; and
in response to detecting the indication, entering a communication session that includes the first electronic device, the second electronic device, and the third electronic device, including:
obtaining first data corresponding to a second origin in the physical environment, wherein the second origin is shared between the second electronic device and the third electronic device;
determining a shared origin in the physical environment using the first data and second data corresponding to the first origin in the physical environment; and
presenting, via the one or more displays, an object corresponding to the shared activity at a first location in the three-dimensional environment relative to the shared origin.

2. The method of claim 1, wherein the first origin in the physical environment corresponds to a first physical location in the physical environment, and the second origin in the physical environment corresponds to a second physical location, different from the first physical location, in the physical environment.

3. The method of claim 1, wherein the first origin in the physical environment corresponds to a first physical object in the physical environment, and the second origin in the physical environment corresponds to a second physical object, different from the first physical object, in the physical environment.

4. The method of claim 1, wherein:
the first origin in the physical environment is determined based on first respective data exchanged between the first electronic device and the second electronic device;
the second origin in the physical environment is determined based on second respective data exchanged between the second electronic device and the third electronic device; and
the first respective data is exchanged independently of the second respective data.

5. The method of claim 1, wherein determining the shared origin in the physical environment using the first data and the second data includes computing a product of at least a first transform associated with the first origin and a second transform associated with the second origin.

6. The method of claim 1, further comprising:
after presenting the object corresponding to the shared activity at the first location in the three-dimensional environment relative to the shared origin, transmitting, to the second electronic device and the third electronic device, third data corresponding to the shared origin in the physical environment.

7. The method of claim 1, further comprising:
while presenting the object corresponding to the shared activity at the first location in the three-dimensional environment relative to the shared origin, detecting an indication of input corresponding to a request to move the object in the three-dimensional environment; and
in response to detecting the indication:
moving the object from the first location to a second location, different from the first location, relative to the shared origin in the three-dimensional environment based on the input.

8. The method of claim 1, wherein determining the shared origin in the physical environment using the first data and the second data includes synchronizing to a respective session identifier from a plurality of session identifiers associated with a user of the first electronic device, a user of the second electronic device, and a user of the third electronic device.

9. A first electronic device comprising:
one or more processors;
memory; and
one or more programs stored in the memory and configured to be executed by the one or more processors, the one or more programs including instructions for performing a method comprising:
detecting an indication of a request to engage in a shared activity with a second electronic device and a third electronic device, wherein the first electronic device is collocated with the second electronic device and the third electronic device in a physical environment, and wherein the first electronic device and the second electronic device share a first origin in the physical environment according to which content is presented in a three-dimensional environment; and
in response to detecting the indication, entering a communication session that includes the first electronic device, the second electronic device, and the third electronic device, including:
obtaining first data corresponding to a second origin in the physical environment, wherein the second origin is shared between the second electronic device and the third electronic device;
determining a shared origin in the physical environment using the first data and second data corresponding to the first origin in the physical environment; and
presenting, via one or more displays, an object corresponding to the shared activity at a first location in the three-dimensional environment relative to the shared origin.

10. The first electronic device of claim 9, wherein the first origin in the physical environment corresponds to a first physical location in the physical environment, and the second origin in the physical environment corresponds to a second physical location, different from the first physical location, in the physical environment.

11. The first electronic device of claim 9, wherein the first origin in the physical environment corresponds to a first physical object in the physical environment, and the second origin in the physical environment corresponds to a second physical object, different from the first physical object, in the physical environment.

12. The first electronic device of claim 9, wherein:
the first origin in the physical environment is determined based on first respective data exchanged between the first electronic device and the second electronic device;
the second origin in the physical environment is determined based on second respective data exchanged between the second electronic device and the third electronic device; and
the first respective data is exchanged independently of the second respective data.

13. The first electronic device of claim 9, wherein determining the shared origin in the physical environment using the first data and the second data includes computing a product of at least a first transform associated with the first origin and a second transform associated with the second origin.

14. The first electronic device of claim 9, wherein the method further comprises:
after presenting the object corresponding to the shared activity at the first location in the three-dimensional environment relative to the shared origin, transmitting, to the second electronic device and the third electronic device, third data corresponding to the shared origin in the physical environment.

15. The first electronic device of claim 9, wherein the method further comprises:
while presenting the object corresponding to the shared activity at the first location in the three-dimensional environment relative to the shared origin, detecting an indication of input corresponding to a request to move the object in the three-dimensional environment; and
in response to detecting the indication:
moving the object from the first location to a second location, different from the first location, relative to the shared origin in the three-dimensional environment based on the input.

16. The first electronic device of claim 9, wherein determining the shared origin in the physical environment using the first data and the second data includes synchronizing to a respective session identifier from a plurality of session identifiers associated with a user of the first electronic device, a user of the second electronic device, and a user of the third electronic device.

17. A non-transitory computer readable storage medium storing one or more programs, the one or more programs comprising instructions, which when executed by one or more processors of a first electronic device, cause the first electronic device to perform a method comprising:
detecting an indication of a request to engage in a shared activity with a second electronic device and a third electronic device, wherein the first electronic device is collocated with the second electronic device and the third electronic device in a physical environment, and wherein the first electronic device and the second electronic device share a first origin in the physical environment according to which content is presented in a three-dimensional environment; and
in response to detecting the indication, entering a communication session that includes the first electronic device, the second electronic device, and the third electronic device, including:
obtaining first data corresponding to a second origin in the physical environment, wherein the second origin is shared between the second electronic device and the third electronic device;
determining a shared origin in the physical environment using the first data and second data corresponding to the first origin in the physical environment; and
presenting, via one or more displays, an object corresponding to the shared activity at a first location in the three-dimensional environment relative to the shared origin.

18. The non-transitory computer readable storage medium of claim 17, wherein the first origin in the physical environment corresponds to a first physical location in the physical environment, and the second origin in the physical environment corresponds to a second physical location, different from the first physical location, in the physical environment.

19. The non-transitory computer readable storage medium of claim 17, wherein the first origin in the physical environment corresponds to a first physical object in the physical environment, and the second origin in the physical environment corresponds to a second physical object, different from the first physical object, in the physical environment.

20. The non-transitory computer readable storage medium of claim 17, wherein:
the first origin in the physical environment is determined based on first respective data exchanged between the first electronic device and the second electronic device;
the second origin in the physical environment is determined based on second respective data exchanged between the second electronic device and the third electronic device; and
the first respective data is exchanged independently of the second respective data.

21. The non-transitory computer readable storage medium of claim 17, wherein determining the shared origin in the physical environment using the first data and the second data includes computing a product of at least a first transform associated with the first origin and a second transform associated with the second origin.

22. The non-transitory computer readable storage medium of claim 17, wherein the method further comprises:
after presenting the object corresponding to the shared activity at the first location in the three-dimensional environment relative to the shared origin, transmitting, to the second electronic device and the third electronic device, third data corresponding to the shared origin in the physical environment.

23. The non-transitory computer readable storage medium of claim 17, wherein the method further comprises:
while presenting the object corresponding to the shared activity at the first location in the three-dimensional environment relative to the shared origin, detecting an indication of input corresponding to a request to move the object in the three-dimensional environment; and
in response to detecting the indication:
moving the object from the first location to a second location, different from the first location, relative to the shared origin in the three-dimensional environment based on the input.

24. The non-transitory computer readable storage medium of claim 17, wherein determining the shared origin in the physical environment using the first data and the second data includes synchronizing to a respective session identifier from a plurality of session identifiers associated with a user of the first electronic device, a user of the second electronic device, and a user of the third electronic device.
